(19) United States
(12) Patent Application Publication
(10) Pub. No.: US 2026/0202079 A1
(43) Pub. Date: Jul. 16, 2026

(54) System and Method for Distributed Predictive Environmental Control with Causal Loop Suppression and Adaptive Path Prediction

(71) Applicants: Nathan Zaugg, Kaysville, UT (US); Kerry Heiner, Wellsville, UT (US)

(72) Inventors: Nathan Zaugg, Kaysville, UT (US); Kerry Heiner, Wellsville, UT (US)

(21) Appl. No.: 19/448,120

(22) Filed: Jan. 14, 2026

Related U.S. Application Data
(60) Provisional application No. 63/745,756, filed on Jan. 15, 2025.

(51) Int. Cl. F24F 11/64; F24F 11/38; F24F 11/46; F24F 11/54; F24F 120/10; G05B 13/04

(52) U.S. Cl. CPC F24F 11/64; F24F 11/38; F24F 11/46; F24F 11/54; G05B 13/048; F24F 2120/10

(57) ABSTRACT

A distributed environmental control system comprises control nodes that communicate via wireless mesh networks to predict user movement and automate loads without centralized coordination. Each node executes a local inference engine (Markov model, HMM/DBN, or reinforcement learning policy) to predict occupancy patterns, broadcasts predictions to neighbors, and makes autonomous actuation decisions based on local and shared data. When multiple nodes control loads in a shared zone, a Runtime Actuation Authority mechanism designates a single decision-maker based on most recent manual interaction, with authority epochs and deterministic total order resolution ensuring distributed consistency. The system prevents feedback loops via causal action identifiers, logical timestamps, and recent action caches. Sensor data is transmitted as compressed waveform encodings. A deterministic policy layer enforces safety and comfort constraints. The reinforcement learning embodiment learns household preferences from user feedback, adapting actuation behavior to optimize satisfaction, comfort, and energy efficiency while maintaining safety guarantees.

### CROSS-REFERENCE TO RELATED APPLICATIONS

This application claims the benefit of U.S. Provisional Patent Application No. 63/745,756, filed Jan. 15, 2025, which is incorporated herein by reference in its entirety.

### FIELD OF THE DISCLOSURE

The present disclosure relates generally to home automation and environmental control systems, and more particularly to distributed AI systems utilizing predictive algorithms for automated lighting and load control.

### BACKGROUND

Conventional home automation systems often rely on a centralized hub or cloud-based controller to process sensor data and issue commands. While effective for simple scheduling, this centralized architecture can introduce latency and creates a single point of failure. The system accounts for the nuanced physical context of a user's movement through a space, not simply reacting only after a user has fully entered a room or triggering falsely on transient motion.

While distributed smart home networking systems (e.g., utilizing Bluetooth Mesh, Thread, or Z-Wave protocols for communication) are used for device coordination, coordination of complex logic across multiple nodes is absent. In a deployment lacking a central arbiter, distributed nodes may issue conflicting commands or react to the consequences of their own automated actions, leading to feedback loops, oscillation (“thrashing”), and user frustration. Existing automation systems lack mechanisms, including causal loop suppression techniques, to prevent causal loops where a node's automated action triggers sensor events that cause further automated responses, creating instability.

Prior distributed smart home systems have employed group messaging, zone-based addressing, and scenario-triggered actuation based on static commissioning configurations. However, these systems lack (a) runtime authority election based on sensor-derived occupancy context and user interaction patterns, (b) causal loop suppression using action identifiers and logical timestamps to prevent automated feedback loops, (c) predictive look-ahead actuation conditioned on learned transition probabilities and Zone Profiles, and (d) adaptive constraint modulation based on reinforcement learning from user corrections. The present disclosure addresses these limitations through a distributed AI architecture that learns, predicts, and coordinates without requiring a central hub or static rule configurations.

Generic distributed messaging systems and message brokers provide ordering guarantees for arbitrary application semantics but do not address the specific safety requirements of automated physical actuation, including prevention of feedback loops between sensors and actuators, deterministic resolution of conflicting load commands, and suppression of duplicate actuations from message redundancy. These actuation-specific coordination challenges require purpose-built mechanisms integrated with the automation logic rather than generic message ordering infrastructure.

### SUMMARY

The present disclosure describes a system and method for distributed, predictive environmental control. In various embodiments, a plurality of control nodes (physical devices comprising a processor, wireless transceiver, sensor array, and load control circuitry) form a distributed AI system where intelligence is partitioned among the nodes rather than centralized. To prevent feedback loops and ensure consistent operation, the system employs a Causal Action Protocol using unique action identifiers, logical timestamps, and distributed conflict resolution.

In a preferred embodiment, the system utilizes a Probabilistic State Machine maintained locally at each node. By analyzing sequential trigger events and applying exponential time decay to behavioral weights (while maintaining stable structural edges), the system learns user patterns and logical “zones” (logical or physical areas such as rooms or hallways) of occupancy through a first-order Markov transition probabilities matrix with probabilities updated online using per-neighbor Exponentially Weighted Moving Average (EWMA) or Beta-style estimators. A predictive look-ahead algorithm facilitates the actuation of downstream loads (electrical devices under control, such as lights or HVAC components) before a user arrives, while a distributed Runtime Actuation Authority protocol manages conflict resolution between nodes controlling the same physical space and may coordinate actions to avoid simultaneous or conflicting pre-wake events.

In a first alternative embodiment, the system employs an Advanced Graph Traversal approach with a variable-order Markov history matrix, incorporating second-order transition probabilities, direction-of-travel disambiguation to more accurately infer movement toward a target node, and waveform-based occupant profiling to achieve enhanced prediction accuracy in complex navigation scenarios such as long corridors, multi-room sequences, or staircases.

In a second alternative embodiment, the system utilizes a Hidden Markov Model (HMM) or Dynamic Bayesian Network (DBN) architecture to smooth latent occupancy states and infer motion intent from noisy sensor emissions, providing robust handling of multi-sensor fusion and temporal consistency by maintaining belief probabilities over node occupancy and updating them online with observed trigger events, optionally combining information from multiple neighboring sensors to improve prediction accuracy.

In a third alternative embodiment, the system implements a Reinforcement Learning (RL) controller configured to adapt automated actuation behavior based on user feedback implicitly expressed through manual interactions and observed sensor-triggered events that indicate successful or missed predictions. In this embodiment, manual user interventions (e.g., physical button presses, touch, gesture, or other local override inputs) are treated as negative feedback signals, such that the RL controller learns a policy that reduces the frequency and severity of undesired automated actions while maintaining responsiveness, comfort, and energy objectives. Positive feedback is inferred when automated actions correctly predict occupancy, allowing the RL controller to reinforce beneficial behaviors. The RL policy adapts to household-specific preferences, routines, and tolerances through continuous learning from outcomes rather than relying solely on pre-programmed rules, with online updates applied incrementally at each node to minimize memory and computation requirements.

All embodiments optionally employ a Extrema-Preserving Keypoint Encoding (EPKE) that serves dual technical purposes: reducing mesh network payload for bandwidth-constrained transmission while extracting sensor features at the temporal scale where occupancy patterns are most discriminative. Raw PIR waveforms contain high-frequency noise that degrades predictive model accuracy; the keypoint representation preserves motion-relevant signal structures (extrema and slope changes corresponding to human movement timescales) while discarding sensor noise that would otherwise reduce pattern recognition performance.

In some embodiments, the system further includes a Deterministic Policy Layer (“Guardrails Layer”) that gates or modifies automated actuation, enforcing configured safety and user-experience constraints (e.g., maximum fade rate, night-time brightness caps, minimum on/off dwell) ensuring that all automated actions respect configured safety limits and dwell times regardless of the underlying predictive model, and preventing rapid or conflicting actuation that could reduce user comfort.

Unlike centralized systems that require constant cloud connectivity and transmit user behavioral data to remote servers, the present disclosure performs all inference and learning locally within the distributed AI system, preserving user privacy, eliminating external service dependencies, and reducing latency in automated responses by performing per-node online updates of predictive models, including transition probabilities, dwell estimates, and optional EPKE features. The system functions fully autonomously without any hub or cloud dependency, enabling real-time predictive actuation with minimal network traffic.

In alternative embodiments, the system may optionally include:
(a) Cloud-Enhanced Modeling wherein the local system transmits anonymized, aggregated usage patterns (not raw sensor data or personally identifiable information) to cloud-based AI services that return improved prediction parameters, allowing the system to benefit from broader pattern analysis while maintaining functional independence from cloud availability, and optionally initializing or refining per-node predictive models such as transition probabilities, dwell times, and EPKE feature parameters; and
(b) Federated Learning wherein only model parameters (not raw sensor data or user behaviors) are shared to the cloud to improve global initialization policies, while all real-time inference and personalization remain fully local, preserving privacy and ensuring that online predictive updates at each node remain autonomous.
(C) Computer Vision Features wherein nodes may optionally include computer vision capabilities with privacy-preserving edge-based processing, extracting occupancy, trajectory, and gesture features without storing or transmitting raw images.

Computer vision processing may be optimized for embedded deployment through reduced-resolution processing, reduced frame rate, hardware acceleration, and selective activation triggered by non-image sensors. An activity indicator may signal when image sensing or computer vision processing is active.

### BRIEF DESCRIPTION OF THE DRAWINGS

FIG. 1 is a schematic diagram illustrating the distributed control node architecture, showing: (A) control nodes, (B) Action Event Packets, (C) Recent Action Cache, and (D) node processor, with message propagation paths illustrated.

FIG. 2 is a logic flow diagram illustrating the “Runtime Actuation Authority” determination, showing election via manual interaction and conflict resolution using deterministic identifiers.

FIG. 3 is a diagrammatic representation of the Adaptive Path Prediction Graph in the preferred embodiment, illustrating Zone nodes, Transition edges, and the application of exponential decay to edge weights.

FIG. 4 is a flowchart of the Control Loop executed by the node processor, detailing the separation of Fact ingestion, Inference generation, policy decision, and Hysteresis-based actuation.

FIG. 5 is a diagram illustrating the signal processing pipeline, including: (B) extrema/inflection hybrid keypoint extraction (EPKE), (C) encoding, and (D) resulting piecewise-linear reconstruction from encoded payloads.

FIG. 6 is a flow diagram illustrating the Deterministic Policy Layer applying hard constraints and selecting an actuation by constrained optimization using sensor-derived context.

FIG. 7 is a diagram illustrating the first alternative embodiment utilizing a variable-order Markov predictor over a zone graph, showing direction-of-travel pruning and waveform-feature-conditioned transition probabilities.

FIG. 8 is a diagram illustrating the second alternative embodiment utilizing a Hidden Markov Model (HMM)/Dynamic Bayesian Network (DBN), showing latent occupancy states, sensor emissions, and belief propagation over time.

FIG. 9 is a diagram illustrating the third alternative embodiment utilizing a Reinforcement Learning controller, showing observation vector construction, policy network, reward computation from user feedback, and integration with the Deterministic Policy Layer.

### DETAILED DESCRIPTION

### 1. Distributed AI Architecture and Autonomous Coordination

A. Core Innovation: Distributed Intelligence with Data Sharing

The fundamental innovation of the present disclosure is a distributed AI system where each control node operates autonomously while sharing sensor data and predictions with neighboring nodes to enable coordinated, predictive environmental control. Unlike conventional centralized systems where a hub processes all data and makes all decisions, this system partitions intelligence across nodes, allowing each node to:
1. Collect Local Sensor Data: Each node observes its environment using sensors (PIR motion, ambient light, proximity, load current, etc.) and captures local user interactions (button presses, manual overrides).
2. Execute Local AI Inference: Each node runs its own inference engine (Markov model, HMM, or RL policy) to predict user movement patterns, occupancy states, and actuation needs.
3. Share Predictions and State Updates: Nodes broadcast their predictions, actuation decisions, and state updates to the distributed AI system via wireless mesh protocols, enabling neighbors to coordinate their behavior.
4. Make Autonomous Actuation Decisions: Each node independently decides when to actuate its connected loads based on local inference, shared predictions from neighbors, and configured constraints (Guardrails).

This distributed architecture provides several technical advantages:
No Single Point of Failure: The system continues to function even if individual nodes fail or lose connectivity.
Low Latency: Inference and actuation occur locally without round-trip delays to a central hub or cloud service.
Privacy Preservation: All sensor data and learning remain within the local network; no behavioral data is transmitted to external servers.
Scalability: Additional nodes can be added without overloading a central processor.
Adaptability: Each node adapts to local conditions and user behavior independently while benefiting from shared learning across the system.
Actuation Safety: Purpose-built coordination mechanisms prevent feedback loops, load state oscillation, and duplicate actuations that would degrade user experience in a distributed automation system lacking a central arbiter.

### B. Data Sharing Via Ordered Control Messages

To enable coordination, nodes exchange Ordered Control Messages (OCMs) over the wireless mesh network. OCMs share common infrastructure for distributed consistency (unique Message ID, logical timestamp, Originating Node ID, optional Message Authentication Code) but differ in their semantic payload:
Action Event Packets (AEPs): Carry automated actuation commands (e.g., LIGHT_ON, DIM_TO_LEVEL) and are subject to loop suppression (Section 3).
Load State Messages: Carry current load states for contextual coordination.
Waveform Update Messages: Carry compressed parametric waveform encodings (Section 5) representing rich sensor data (e.g., PIR motion signatures).
Model Update Messages: Carry learned model parameters (e.g., transition probabilities, edge weights) for distributed model synchronization.
Belief Exchange Messages: Carry occupancy belief distributions in the HMM/DBN embodiment (Section 9).
Runtime Actuation Authority Messages: Carry authority claims, announcements, and state updates (Section 2.A).

Transport Independence: The OCM family is semantically defined at the application layer and is independent of the underlying message delivery mechanism. OCMs may be delivered via unicast, broadcast flooding, standards-based IP multicast (e.g., IPv6 multicast over Thread), or protocol-specific group messaging (e.g., Bluetooth Mesh group addresses, Zigbee group addressing). The inventive coordination semantics-including causal loop suppression, Runtime Actuation Authority election, belief exchange, and constraint enforcement-operate identically regardless of which transport-layer delivery mechanism is employed. No specific multicast encapsulation scheme, distribution node architecture, or group routing protocol is required; the system functions correctly using any delivery mechanism that provides eventual message propagation to relevant nodes.

By sharing these messages, nodes build a distributed understanding of the environment: each node knows not only its own local observations but also the recent predictions, actuations, and state beliefs of neighboring nodes. This shared context enables sophisticated coordination behaviors:
Predictive Path Lighting: Each node publishes observations and derived features indicative of occupant movement (e.g., PIR waveform features, proximity assertions, and recent actuation outcomes). Upon receiving such messages, a given node performs local inference and policy evaluation to decide whether to actuate its own load preemptively; the messages are informational and are not targeted predictions, commands, or remote actuation requests.
Distributed Occupancy Tracking: Nodes share occupancy beliefs, enabling the system to track user location across multiple zones and avoid false vacant determinations.
Coordinated Fade Sequences: Nodes can coordinate brightness transitions to create smooth, aesthetically pleasing lighting scenes (e.g., gradually dimming the living room while brightening the bedroom as the user prepares for sleep).

### C. Load Groups and Profiles:

Within a single Zone, loads may be organized into groups with distinct functional profiles:
Primary/Task Lighting: Bright, frequently-used loads for primary activities
Ambient/Accent Lighting: Soft or decorative loads for mood lighting
Situational Loads: Rarely-used loads for specific contexts (security, maintenance, special occasions)

Load groups may be configured manually or inferred automatically from observed usage patterns. The AI models learn per-group actuation preferences and inter-group influence relationships.

### D. Network Topology and Communication

The distributed AI system comprises a plurality of control nodes that communicate via a wireless mesh network. The mesh network transport layer may employ various protocols including Bluetooth Mesh, Thread (an IPV6-based mesh protocol), Matter (an application-layer protocol operating over Thread, Wi-Fi, or Ethernet), Zigbee (including Home Automation profiles), Z-Wave, or other suitable low-power wireless protocols.

The distributed AI coordination protocol comprises the following message categories:
Actuation Messages: Action Event Packets carrying automated commands
Learning Messages: Model parameters, transition probabilities, and belief distributions
Coordination Messages: Runtime Actuation Authority claims, announcements, and conflict resolution
Sensor Telemetry: Raw and processed sensor data including PIR waveforms, ambient light, mmWave radar, proximity, temperature, humidity, load current, computer vision features (derived image features, occupancy counts, gesture labels), and other environmental or occupancy measurements

In implementations using standardized application-layer protocols such as Matter or Zigbee Home Automation profiles, the distributed AI messages may be encapsulated within vendor-specific cluster commands or custom attributes. In implementations using lower-level protocols such as Bluetooth Mesh or Thread, the distributed AI messages are transmitted directly as application payloads. The choice of delivery mechanism (unicast, multicast, broadcast, or flooding) is an implementation detail determined by the underlying protocol stack and network topology; the distributed AI coordination protocol imposes no requirements on the transport-layer delivery mechanism and does not rely on any specific multicast routing architecture, distribution node, or encapsulation scheme.

The distributed AI system operates autonomously without requiring central coordination. In some implementations, the system may include a local hub or gateway for diagnostic logging, cloud-based analytics, or firmware updates.

### E. Coordination Modes: Autonomous, Authoritative, and Contextual

The system employs three coordination modes depending on the relationship between nodes and their controlled loads:
1. Autonomous Mode (Independent Zones) Nodes controlling loads in different physical zones operate independently and actuate only their own associated loads. Each node makes local actuation decisions using its own sensor data and locally computed model outputs. Nodes may optionally exchange observational context (e.g., occupancy assertions, sensor-derived features, recent actuation outcomes, and scene state) to improve situational awareness and multi-zone consistency; however, such exchanges are informational and do not constitute targeted predictions, commands, or remote actuation requests.

Example: Hallway node and bedroom node operate autonomously—they control different spaces and their load states don't conflict.
2. Authoritative Mode (Conflicting Loads in Shared Zone) When multiple nodes control the same physical load (e.g., three-way switch configuration) or loads that would create conflicting states if both were active, coordination becomes necessary to prevent conflicting commands. The system employs a Runtime Actuation Authority mechanism (Section 2) to designate a single node as the authoritative decision-maker.

Example: Two switches controlling the same hallway lights must coordinate—the Runtime Actuation Authority makes actuation decisions while the other node defers.
3. Contextual Mode (Influencing Loads in Shared Zone) When multiple nodes control different load groups within the same zone, their decisions don't directly conflict, but the state of one load group influences the optimal state of another. Nodes share their actuation decisions and current load states, allowing other nodes to make contextually-aware decisions without requiring authority-based coordination.

### Example 1—Kitchen with Multiple Lighting Modes

Node A controls candelabra lights (soft, ambient lighting)
Node B controls can lights (bright, task lighting)
User sometimes uses candelabra alone, sometimes can lights alone, sometimes both together
When Node A actuates candelabra lights, it broadcasts this state. Node B's AI model learns: “If candelabra lights are already on, reduce confidence for auto-actuating can lights” (user may prefer soft lighting). Conversely, if the user manually turns on can lights while candelabra is on, both controllers learn this is a valid combination for certain contexts.

### Example 2—Entry with Situational Lighting

Node A controls primary entry lights (used routinely)
Node B controls secondary accent lights (used occasionally)
Node C controls closet-adjacent lights (rarely used except when away or searching a nearby closet)
Nodes share their actuation states. The AI models learn usage patterns: Node A actuates frequently during entry/exit; Node B actuates when hosting guests (correlated with evening hours); Node C actuates only on explicit manual activation or when system detects “away mode” (maintaining appearance of occupancy).

In Contextual Mode, nodes broadcast Load State Messages containing:
Node ID
Load group identifier (e.g., “kitchen_ambient”, “kitchen_task”, “entry_primary”)
Current state (ON/OFF, brightness level, fade parameters, and other sensor data)
Actuation trigger (automated vs. manual, confidence score if automated)
Zone Profile and context tags (e.g., “soft_lighting_mode”, “away_mode”)

Receiving nodes incorporate these Load State Messages into their observation vectors (Section 10.B) or as contextual modifiers to transition probabilities (Sections 7, 8, 9, 10), enabling the AI models to learn:
Which load combinations are typical vs. rare
Which loads are mutually exclusive (one OR the other, not both)
Which loads are complementary (often used together)
Situational preferences (time-of-day, manual override patterns, etc.)

Hybrid Coordination: A single zone may involve multiple coordination modes simultaneously. For example, a kitchen might have:
Node A and Node B in Contextual Mode (candelabra and can lights influence each other)
Node C and Node A in Authoritative Mode (two switches controlling the same candelabra lights)

The system employs this multi-modal coordination approach: autonomous by default, authoritative when necessary, and contextual when beneficial. This approach balances system responsiveness, distributed consistency, and intelligent context-awareness.

### F. AI Models Operating on Shared Data

Each node runs an AI model that consumes both local sensor data and shared data from neighbors. The specific AI architecture varies by embodiment:
Preferred Embodiment (Section 7): Probabilistic State Machine with first-order Markov transition probabilities. Each node maintains its own local Zone graph and transition weights and updates them from Fact streams consisting of (i) its own sensor triggers and (ii) sensor telemetry/trigger evidence broadcast by other nodes (e.g., waveform encodings, trigger events, and recent actuation context). Nodes may broadcast sensor-derived Facts to all peers and may optionally broadcast prediction/intent outputs (e.g., likely next Zone and confidence) to support look-ahead in connected/adjacent zones. Receiving nodes treat these messages as additional observations and may update their local probabilities for transitions relevant to their own Zones, while actuation remains autonomous by default; only shared-load/shared-zone scenarios require Runtime Actuation Authority/DTOR coordination.
First Alternative Embodiment (Section 8): Variable-order Markov predictor (e.g., second-order history) over the Zone graph with direction-of-travel disambiguation. Nodes broadcast Waveform Update Messages carrying compressed keypoint/Δt waveform encodings (and optionally derived feature metadata). Each node derives a low-dimensional signature φ from the waveform, assigns it to a coarse cluster k, and maintains separate transition weights per cluster

$${W}_{i j}^{( k )}$$

(optionally also conditioned on prior Zone Zᵢ₋₁), with fallback to lower-order models when data is sparse. This enables “per-occupant-like” personalization without storing explicit user identities.
Second Alternative Embodiment (Section 9): Hidden Markov Model (HMM) or Dynamic Bayesian Network (DBN) for latent occupancy and intent smoothing from noisy sensor emissions. Nodes may broadcast occupancy belief distributions (via Belief Exchange Messages). Receiving nodes treat these packets as additional observational Facts (subject to deduplication/cache rules to prevent inference loops) and may incorporate them as supplemental evidence or priors during belief updates, enabling distributed probabilistic inference while each node still performs local filtering and makes autonomous actuation decisions.
Third Alternative Embodiment (Section 10): Reinforcement Learning (RL) controller with Guardrails. Each node learns a local policy from trajectories (oₜ, aₜ, rₜ, oₜ₊₁), where reward is computed from user corrections within a window Δ (negative feedback) and optionally from comfort/energy proxies and actuation success/failure. Nodes may optionally share recent actions and outcomes as observational Facts—for example, AEPs that include causal metadata plus an “override/no-override within Δ” outcome field, or a dedicated reward/outcome message type-so that other nodes can treat these as off-policy experience samples (positive or negative examples) to accelerate local learning while actuation remains autonomous by default.

In all embodiments, the AI models leverage shared data to improve prediction accuracy, reduce false positives/negatives, and enable coordinated multi-zone automation sequences.

### G. Privacy and Security Considerations

Because nodes share sensor data and predictions across the mesh network, the system includes optional security mechanisms to prevent eavesdropping, spoofing, and unauthorized control. In many deployments, some of these protections are already provided by the underlying transport (e.g., Zigbee/Thread/Matter), but application-layer protections may still be desirable depending on threat model and topology (e.g., bridged networks, logging, mixed transports, or untrusted intermediaries).
Baseline Transport Security (Implementation-Dependent): When OCMs are carried over secured stacks, link/network-layer protections may provide confidentiality and integrity in transit (e.g., Zigbee uses AES-128 with a network key and can additionally use APS link keys for end-to-end protection; Thread uses a network-wide MAC-layer key; Matter secures operational messaging and supports group keying for multicast). Note that hop-by-hop protections (e.g., Zigbee network-key security) do not necessarily provide end-to-end confidentiality across intermediate routers, so sensitive payloads may still warrant application-layer protection.
Message Authentication (Section 2.D): OCMs may include cryptographic MACs or digital signatures (and anti-replay metadata, such as monotonic counters or timestamps) to verify message integrity and sender authenticity-particularly when messages traverse bridges, are stored/relayed, or require end-to-end assurance independent of the transport.
Network Segmentation: The mesh network may be segmented (e.g., separate cryptographic domains/keys, separate PANs/fabrics, or VLAN-backed isolation for IP backhauls) to isolate sensitive zones (e.g., bedrooms) from less sensitive zones (e.g., garage).
Anonymization/Data Minimization: Waveform encodings, derived features, and occupant-like clusters are anonymized (no names or explicit identities) and may be minimized (e.g., coarse features/clusters rather than raw waveforms), reducing privacy risk even if messages are intercepted or later exposed.

These mechanisms are optional and may be selectively enabled based on deployment security requirements and the protections already provided by the chosen network stack.

### 2. Distributed Consistency and Runtime Actuation Authority

A. Runtime Actuation Authority Election with Authority Epochs

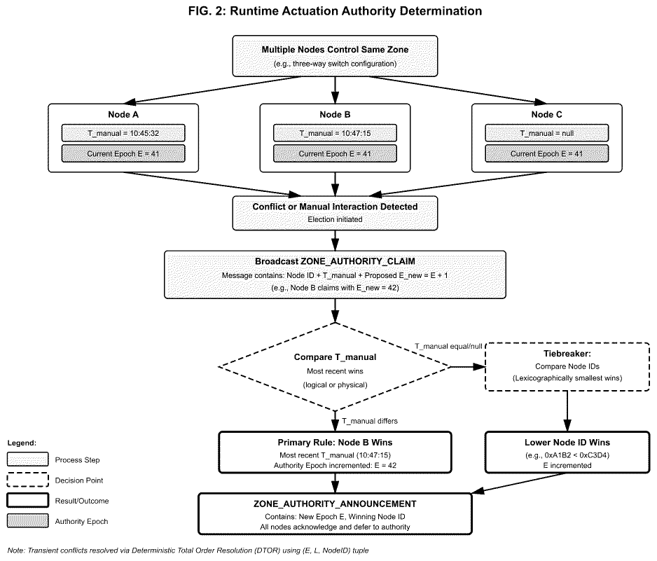

As shown in FIG. 2, when multiple nodes control the same physical load (e.g., three-way switch configuration) or loads with mutually exclusive states, a conflict may arise if nodes issue contradictory commands. To resolve such conflicts, the system designates a single node as the Runtime Actuation Authority for that Zone. This runtime authority governs sensor-driven automated actuation decisions and is distinct from network provisioning or configuration authority (which determines device membership in the mesh network). The Runtime Actuation Authority is dynamically elected based on user interaction patterns and sensor-derived context, not statically assigned during network commissioning. The Runtime Actuation Authority is determined via the following election protocol:
1. Authority Epoch Initialization: Each Zone maintains an Authority Epoch E, a monotonically increasing integer that increments whenever authority transfers to a new node. The epoch disambiguates authority claims across node reboots, network partitions, and delayed message propagation, preventing split-brain conditions.
2. Manual Interaction as Election Trigger: Each node maintains a local timestamp Tₘₐₙᵤₐₗ recording the most recent manual override event (e.g., a physical button press, voice command, or a message sent via a device). Tₘₐₙᵤₐₗ may be implemented as either: (a) a logical clock value piggybacked on manual interaction events, eliminating the need for synchronized physical clocks, or (b) a monotonic local clock value, where comparison across nodes is performed by exchanging logical ordering rather than comparing raw timestamp values.
3. Election Protocol: Whenever a node receives a conflicting command or state update from another node in the same Zone, or when a manual interaction occurs locally, the node initiates an election by broadcasting a ZONE_AUTHORITY_CLAIM message containing:
   Node ID
   Manual Interaction Timestamp Tₘₐₙᵤₐₗ (logical or physical)

$$\begin{matrix}∘ & Proposed Authority Epoch {E}_{new}\end{matrix} = {E}_{current} + 1$$

All nodes in the Zone receive the claim and compare the timestamps. The node with the most recent manual interaction wins the election. In case of a tie (simultaneous manual interactions at multiple nodes), the node with the lexicographically smallest Node ID wins (deterministic tiebreaker).
4. Authority Transfer: The winning node increments the Authority Epoch E←E_{new}, broadcasts a ZONE_AUTHORITY_ANNOUNCEMENT containing the new epoch and its Node ID, and assumes authority. All other nodes in the Zone acknowledge the new authority and defer to its commands.
5. Lease Semantics (Optional): To prevent indefinite authority retention by a non-responsive node, authority may include a lease duration. If the authority node fails to broadcast a heartbeat or actuation command within the lease period, other nodes may initiate a new election.
6. Persistence of Authority Epochs (Optional): The Authority Epoch E may optionally be persisted to non-volatile storage (e.g., EEPROM, flash memory) at each node. Upon reboot, a node implementing epoch persistence reads the persisted epoch value and uses E_{restored}+1 as its initial epoch claim, ensuring that a rebooting node cannot inadvertently claim stale authority using an outdated epoch. Alternatively, systems without persistent storage may rely on logical clock synchronization and heartbeat messages to re-establish authority after reboots.

Distinction from Provisioning Authority: Network provisioning authority (determining which devices may join the mesh, assigning network addresses, distributing security credentials) is handled by standard mesh protocols (e.g., Bluetooth Mesh Provisioner role, Thread Commissioner role, Matter Admin role) and is orthogonal to Runtime Actuation Authority. A node may hold provisioning authority without holding Runtime Actuation Authority for any zone, and vice versa. The inventive concept resides in the runtime election of actuation authority based on sensor-derived occupancy context, user interaction recency, and Zone Profile constraints-not in network-layer provisioning.

This election protocol ensures that conflicting commands are resolved deterministically and consistently across all nodes, even in the presence of network delays, partitions, or node failures.

### B. Zone Profile and Context-Specific Runtime Authority

The Runtime Actuation Authority election may be influenced by Zone Profile, a categorical classification that may be (i) manually configured during commissioning, (ii) automatically inferred from observed sensor patterns and user interaction history, or (iii) dynamically updated based on time-of-day, detected occupancy patterns, or learned behavioral context. Unlike static scene or scenario configurations in prior systems, Zone Profiles serve as runtime conditioning inputs to the prediction, coordination, and constraint-modulation algorithms rather than as fixed mappings from triggers to actions. For example:
Bedroom Zones: Prioritize the node physically located inside the bedroom (determined by manual configuration or sensor topology) to respect occupant privacy and avoid external override.
Hallway Zones: Use proximity sensing to elect the node nearest to the detected occupant, ensuring that path lighting follows the user's actual position.
Multi-Function Zones (e.g., Kitchen/Dining): Allow multiple nodes to hold partial authority over different load groups (e.g., Node A controls task lighting, Node B controls ambient lighting), with coordination via shared state rather than exclusive authority.

These context-specific behaviors enhance user experience by adapting the authority protocol to the physical and functional characteristics of each Zone.

### C. Conflict Resolution Via DTOR

Even with a designated Runtime Actuation Authority, transient conflicts may occur due to network delays or race conditions (e.g., two nodes issue commands before the authority election completes). To handle such cases, the system employs Deterministic Total Order Resolution (DTOR) (described in detail in Section 3.F), which uses Authority Epoch, logical timestamps, and Node IDs to establish a total order on conflicting messages, ensuring all nodes converge to the same state.

### D. Security and Message Authentication (Optional Enhancement)

To prevent malicious or erroneous nodes from disrupting the distributed system, some deployments employ cryptographic message authentication. Several alternative approaches may be used:
1. Shared Network Key (Symmetric): All nodes in the distributed AI system share a common secret key Kₙₑₜ (provisioned during commissioning). Each message includes an HMAC-SHA256 computed over the message fields:

$$MAC = HMAC ( {K}_{net} , MessageFields )$$

Receiving nodes verify the MAC before processing the message. This approach is computationally lightweight but requires secure key distribution and offers no per-node accountability.
2. Per-Node Keys (Symmetric with Key Table): Each node has a unique secret key Kᵢ, and all nodes maintain a key table mapping Node IDs to keys. Messages include a MAC computed with the sender's key. This enables per-node authentication and revocation (by removing a node's key from the table), at the cost of increased key management complexity.
3. Asymmetric Signatures (Public Key Cryptography): Each node has a private/public key pair (SKᵢ, PKᵢ). Messages include a digital signature (e.g., Ed25519 or ECDSA) computed with the sender's private key. All nodes maintain a table of public keys. This provides strong non-repudiation and per-node accountability, but requires more computational resources (potentially limiting use on ultra-low-power nodes).
4. Key Rotation and Revocation: The network key or per-node keys may be rotated periodically. A key rotation message, authenticated using the old key and containing the new key encrypted under node-specific keys, is broadcast to update all nodes.
5. Nonce and Replay Prevention: To prevent replay attacks (where an adversary retransmits a captured valid message), messages may include a nonce or monotonic sequence number. Receiving nodes reject messages with stale or duplicate sequence numbers.

These security mechanisms are optional and may be selectively enabled based on deployment requirements (e.g., high-security commercial installations vs. home deployments with lower threat models).

### 3. Causal Action Protocol and Loop Suppression

### A. Problem Statement: Automated Feedback Loops

In a conventional automation system, a node may actuate a load (e.g., turning on a light) in response to a sensor trigger (e.g., motion detection). This actuation may itself generate subsequent sensor triggers (e.g., the light turning on causes a brightness sensor threshold crossing at a neighboring node), which may in turn cause further automated actions, creating a feedback loop. Such loops can cause “thrashing” behavior (rapid on/off cycling), unpredictable system states, and degraded user experience.

### B. Action Event Packets (AFPs) and Ordered Control Messages

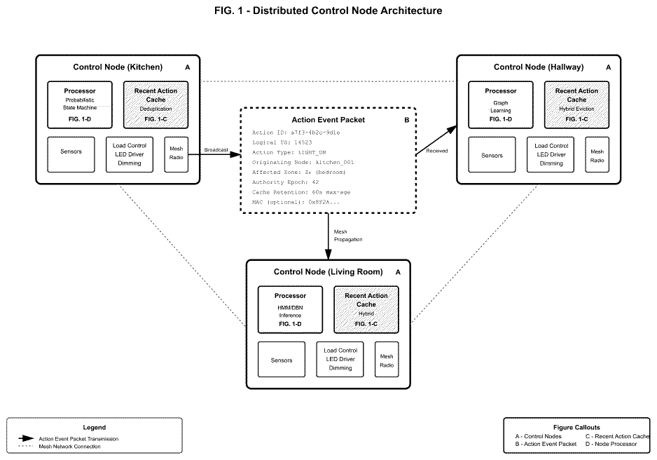

To prevent such loops, the system introduces the concept of an Action Event Packet (AEP). As shown in FIG. 1 (element B), an AEP is a data structure broadcast on the distributed AI system whenever a node performs an automated actuation. AEPs specifically carry automation commands and are subject to loop suppression and cache-based deduplication as described in this section.

Ordered Control Message Family: The distributed AI system employs an Ordered Control Message (OCM) family comprising multiple message types that all share common infrastructure for distributed consistency (unique Message ID, logical timestamp, Originating Node ID, optional Message Authentication Code) but differ in their semantic payload and processing. The OCM family includes:
Action Event Packets (AEPs): Actuation/automation messages that carry commands (e.g., LIGHT_ON, DIM_TO_LEVEL) and are subject to loop suppression via the Recent Action Cache (Section 3.C).
Sensing Update Messages: Updates from other devices that includes information like the ALS, PIR, mmWave, or other sensors.
Model Update Messages: Carry learned model parameters (e.g., transition probabilities, HMM belief states) for distributed model synchronization.
Belief Exchange Messages: Carry occupancy belief distributions in the HMM/DBN embodiment (Section 9).
Runtime Actuation Authority Messages: Carry authority claims, announcements, and state updates as described in Section 2.A.

All Ordered Control Messages share this distributed consistency infrastructure, with logical timestamps for DTOR ordering (Section 3.F) and optional Cache Retention Control fields. The ordering and consistency mechanisms are purpose-built for actuation safety in sensor-driven environmental control rather than for generic message ordering:
Logical timestamps enable causal loop detection and suppression, preventing automated actions from triggering cascading sensor events that cause further automated responses (Section 3.D).
Authority epochs ensure that conflicting actuation commands converge to a single deterministic outcome, preventing “thrashing” between competing brightness levels or on/off states that would degrade user experience and accelerate hardware wear.
Unique action identifiers and cache-based deduplication prevent duplicate physical actuations from redundant message propagation, ensuring that a single user movement does not cause multiple load state changes.
Causal chain tracking enables credit assignment for reinforcement learning (tracing which predictions led to user corrections) and debugging of unexpected automation cascades.

These domain-specific safety invariants-physical actuation consistency, feedback loop prevention, and user experience protection-distinguish the OCM family from generic message ordering or broker systems where ordering serves arbitrary application semantics. AEPs are the most frequently used OCM type, as they carry all automated actuation commands. The OCM family defines application-layer message semantics and coordination rules; it is agnostic to the transport-layer delivery mechanism and functions identically whether messages are delivered via unicast, flooding, IP multicast, or protocol-specific group addressing.

### Action Event Packet (AEP) Fields: An AEP Contains (at Minimum):

1. Action ID: A globally unique identifier enabling action deduplication and origin identification (e.g., composed from Node ID and local counter, UUID, or hash-based construction).
2. Logical Timestamp: A logical clock value (e.g., Lamport scalar clock or vector clock entry, etc.) providing a partial order on events.
3. Action Type: An enumeration indicating the nature of the action (e.g., LIGHT_ON, LIGHT_OFF, DIM_TO_LEVEL).
4. Originating Node ID: The identifier of the node that initiated this action.
5. Affected Zone/Load ID: Identifies which logical load or zone this action applies to. In typical operation, each node actuates its own physically connected loads based on local sensor data and AI predictions. AEPs primarily serve to synchronize predicted state across the distributed system for conflict resolution via DTOR rather than as direct commands to other nodes. In situations with sensor-only nodes or multi-switch configurations, this field enables the appropriate actuator node to identify relevant actions.
6. Causal Chain (Optional): A list of prior Action IDs that led to this action, forming an explicit causal chain. This enables advanced loop detection (preventing circular causality), credit assignment in the RL embodiment (tracing which predictions led to user feedback), multi-step pattern learning (understanding cascading predictions across zones), and debugging of unexpected automation behavior.
7. Cache Retention Control: To control cache retention and message propagation behavior, the AEP may include:
   Cache Retention Control: Specifies how long the packet should be retained in the Recent Action Cache. This may be encoded as:
   Max-Age: Maximum duration (in seconds or milliseconds) measured from the time of first receipt at a node.
   Absolute Expiry: An absolute timestamp beyond which the packet should be discarded. This variant requires loose time synchronization across nodes, which may be achieved via Network Time Protocol (NTP), mesh-based time synchronization protocols, or in outdoor/specialized deployments, GPS time references. Receiving nodes may apply a clock skew tolerance ϵ (e.g., ϵ=2 seconds) to the expiry comparison, treating messages as valid if current_time<absolute_expiry+\epsilon, to avoid premature discarding in networks with minor clock drift.
8. Authority Epoch: The Authority Epoch number of the issuing node, used for deterministic conflict resolution via DTOR (Section 2.A). In deployments without Runtime Actuation Authority, this field may be omitted.
9. Message Authentication Code (Optional): The AEP may include a cryptographic MAC (e.g., HMAC-SHA256) computed over the packet fields using a shared network key, per-node key, or asymmetric signature to prevent spoofing and ensure message integrity.

### C. Recent Action Cache

As shown in FIG. 1 (element C), each node maintains a Recent Action Cache, implemented as a hash table indexed by Action ID or a circular buffer with linear search. Upon receiving or generating an AEP, the node checks whether the Action ID exists in the cache. If present, the AEP is a duplicate and is discarded. Otherwise, the node inserts the Action ID and timestamp.

Cache Timestamp Semantics: The timestamp stored in the cache is the first-seen time at the receiving node (i.e., the node's local clock value when the AEP was first received or generated locally) and shall not be refreshed on duplicate receipt of the same Action ID. This ensures consistent cache retention behavior and prevents replay attacks or loops from extending the lifetime of stale actions.

The cache employs a hybrid eviction policy that enforces both temporal and capacity constraints concurrently:
Time-Based Eviction: Entries older than a configured retention duration are discarded. The retention duration may be specified by:
   The Max-Age value from the AEP's Cache Retention Control field (if present), measured from the first-seen timestamp.
   An Absolute Expiry timestamp from the AEP (if present), compared against the current time.
   A default maximum age (e.g., 60 seconds) if no explicit Cache Retention Control is specified in the AEP.
   The node periodically scans the cache (e.g., every 5 seconds) or performs lazy eviction on lookup.
Count-Based Eviction: The cache maintains a maximum capacity (e.g., 100 entries). When the cache is full and a new entry must be inserted, the oldest entry (by first-seen timestamp or by expiry time) is evicted using a FIFO or LRU policy.

By enforcing both constraints, the system guarantees bounded memory usage while ensuring that stale causal information does not persist indefinitely. In one embodiment, the cache eviction routine operates as follows:

```
on_cache_insert(action_id, first_seen_time, retention_control):
  if cache.size >= MAX_CAPACITY:
    evict_oldest_entry( )
  prune_expired_entries(current_time)
  cache.insert(action_id, first_seen_time, retention_control)
```

where prune_expired_entries removes all entries where:
current_time-first_seen_time>max_age (if retention_control specifies max-age), or
current_time>absolute_expiry (if retention_control specifies absolute expiry).

### D. Loop Suppression Logic

When a node observes a sensor trigger (Fact), and the Policy Layer proposes an automated action, the node checks whether this proposed action would be causally downstream of a recently observed AEP. Specifically:
1. The node examines the Recent Action Cache to determine if any recent AEP involved the same Target Node and Action Type (or a related action in the same Zone).
2. If such an AEP is found and its timestamp is within a configured suppression window (e.g., 5 seconds), the node tags the proposed action as “potentially causal” and applies one of the following suppression strategies:
   Strategy A (Strict Suppression): The node blocks the automated action entirely, logging a “LOOP SUPPRESSED” event.
   Strategy B (Confidence Penalty): The node reduces the Confidence Score S associated with the action by a penalty factor (e.g., S←S×0.5), allowing the Hysteresis Layer (Section 7.E) to gate the action based on the reduced confidence.
   Strategy C (Causal Chain Analysis): The node inspects the Causal Chain field of the cached AEP to determine if the proposed action would re-trigger a prior action in the chain, forming a cycle. If a cycle is detected, the action is suppressed.
3. If no causal conflict is detected, the node proceeds with the action and broadcasts a new AEP containing the appropriate Action ID and causal metadata.

### E. Logical Timestamps and Ordering

To ensure that nodes converge on a consistent understanding of event ordering (critical for conflict resolution and Runtime Actuation Authority election, as described in Section 2), the system employs logical clocks. Each node maintains a local logical clock L, initialized to zero. Upon generating or receiving an AEP with timestamp Lᵣₑₘₒₜₑ, the node updates its clock:

$$L ← max ( L , {L}_{r e m o t e} ) + 1$$

This ensures that all events are assigned a consistent partial order, even in the absence of globally synchronized physical clocks.

Logical Clock Counter Overflow Handling: The logical clock may be represented as a 64-bit unsigned integer, providing a range of 2⁶⁴-1 values (approximately 1.8×10¹⁹). Even at an extreme event rate of 1,000 events/second, this provides over 500 million years of operation before overflow, making wraparound effectively negligible in practice and eliminating the need for explicit overflow handling.

For implementations using smaller counter representations (e.g., 32-bit counters), the system may handle potential overflow via one of the following mechanisms:
Wraparound with Comparison Logic: The node treats the logical clock counter as a circular sequence number and uses modular arithmetic for comparisons, similar to TCP sequence number handling (e.g., treating values as “recent” if within a specified window).
Epoch or Session Identifier: Each node includes a boot epoch or session identifier in messages. When a node reboots and resets its logical clock to zero, the new session identifier disambiguates the reset counter from the pre-reboot sequence.
Counter Reset on Authority Transfer: The logical clock counter for a Zone may be reset to zero when a new Authority Epoch begins, preventing unbounded growth and aligning logical time with authority epochs.

Domain-Specific Purpose of Logical Ordering: The logical timestamp mechanism serves actuation safety rather than general-purpose event ordering. Specifically, logical ordering enables: (i) identification of causal relationships between automated actions and subsequent sensor triggers for loop suppression, (ii) deterministic resolution of conflicting actuation commands issued by multiple nodes within a suppression window, and (iii) consistent cache expiration behavior across nodes without requiring synchronized physical clocks. The partial order established by logical timestamps is sufficient for these actuation safety purposes; total ordering of all system events is neither required nor maintained.

Non-Requirement of Physical Clock Synchronization: The system explicitly does not require synchronized physical clocks across nodes. All ordering, conflict resolution, and coordination mechanisms operate using logical clocks (Lamport clocks or vector clocks) that establish causal ordering without wall-clock agreement. Where absolute expiry timestamps are optionally used for cache retention (Section 3.B.7), a configurable clock-skew tolerance ϵ accommodates loose time synchronization; however, absolute expiry is an optional optimization, and the system functions correctly using only relative max-age values that require no inter-node time coordination. This design ensures robust operation in mesh networks where physical clock drift is common and NTP or GPS time references may be unavailable.

### F. Deterministic Total Order Resolution (DTOR)

When multiple nodes issue conflicting commands or state updates (e.g., two nodes simultaneously commanding different brightness levels for the same Zone), the system employs Deterministic Total Order Resolution (DTOR) to select a single winning message and ensure all nodes converge to the same state.

The DTOR algorithm operates as follows:
1. Ordering Tuple Construction: Each command or state update message includes an ordering tuple:

$$Order = ( E , L , NodeID )$$

where E is the Authority Epoch number (Section 2.A), L is the logical clock value, and NodeID is the unique node identifier.
2. Lexicographic Comparison: When a node receives multiple conflicting messages, it compares their ordering tuples lexicographically:
   Primary Sort: Higher Authority Epoch E wins (messages from a node with more recent authority take precedence).
   Secondary Sort: If epochs are equal, higher logical timestamp L wins (more recent messages take precedence).
   Tertiary Sort: If both epoch and timestamp are equal, lower NodeID wins (deterministic tiebreaker using lexicographical byte comparison).
3. State Convergence: The node applies the command from the winning message and discards conflicting messages with lower ordering tuples. All nodes performing this comparison independently will arrive at the same decision, ensuring distributed consistency.
4. Conflict Notification (Optional): When a node detects a conflict, it may broadcast a CONFLICT RESOLUTION message containing the winning ordering tuple. Nodes that had tentatively applied a losing command roll back to the winning state.

By establishing a deterministic total order, DTOR ensures that the distributed system exhibits consistent behavior even under network partitions, message delays, or simultaneous conflicting actions, without requiring a central arbiter or consensus protocol.

4. Adaptive Graph Weight Updates with Exponential Decay
A. Transition Weight Accumulation with Per-Edge Timestamps

When a user transitions from Zone Zᵢ to Zone Zⱼ (detected by sequential trigger events at time t_{now}), the system updates the transition weight Wᵢⱼ and records the current timestamp as the last update time for that edge.

To maintain correct exponentially-forgetting event count semantics, the stored weight is first decayed forward to the current time before incrementing:

$$\begin{matrix}{W}_{ij} ← {W}_{ij} \cdot {e}^{- λ ( {t}_{now} - {t}_{last , ij} ) + 1} \\ {t}_{last , ij} ← {t}_{now}\end{matrix}$$

where λ>0 is the decay constant

$$( e . g . , λ = \frac{ln 2}{τ}$$

for a half-life of τ seconds). This forward-decay-then-increment procedure ensures that long gaps between transitions properly reduce the influence of older observations, preventing the weight from becoming artificially inflated.

Alternatively, for simpler implementation with slightly different decay semantics, the system may increment without forward decay:

$$\begin{matrix}{W}_{i j} ← {W}_{i j} + 1 \\ {t}_{last , ij} ← {t}_{now}\end{matrix}$$

and rely solely on lazy projection at probability computation time. This variant is computationally lighter but treats each increment as occurring “at the stored weight's value,” which may overweight recent transitions in some edge cases.

The timestamp t_{last,ij} is a per-edge timestamp (stored alongside Wᵢⱼ) that tracks when the weight was last updated. This timestamp may be implemented as either a monotonic clock value (milliseconds since node boot) or a wall-clock timestamp (Unix epoch milliseconds).

This per-edge timestamp storage enables accurate lazy decay computation without requiring global time synchronization or continuous background processing.

B. Exponential Decay for Behavioral Adaptation with Lazy Projection

To allow the system to adapt to changing user behavior over time, the transition weights are subject to exponential time decay. Rather than continuously decrementing weights in the background, the system applies decay lazily when computing transition probabilities.

When the node computes probabilities at time t_{now}, it projects each edge weight to its current decayed value:

$${W}_{ij}^{decayed} ( {t}_{now} ) = {W}_{ij}^{stored} \cdot {e}^{- λ ( {t}_{now} - {t}_{last , ij} )}$$

where:

$${W}_{ij}^{stored}$$

is the stored (undecayed) weight value from the last increment.
λ>0 is the decay constant

$$( e . g . , λ = \frac{ln 2}{τ}$$

for a half-life of τ seconds).
(t_{now}−t_{last,ij}) is the elapsed time since the edge was last incremented.

Typical values are τ=30 days (slow adaptation) to τ=7 days (moderate adaptation) to τ=1 day (rapid adaptation), with τ configurable based on household dynamics.

### C. Inactive Threshold and Numerical Stability

Because exponential decay drives weights toward zero asymptotically, the system defines an inactive threshold Wₘᵢₙ (e.g., Wₘᵢₙ=0.01). When a decayed weight falls below this threshold, it is treated as effectively zero for probability computation, preventing numerical instability and ensuring that very old, stale transitions do not contribute meaningfully to predictions.

Weights below Wₘᵢₙ may be clamped to zero, or a small additive smoothing constant (Laplace smoothing) may be applied to maintain non-zero probabilities for all edges:

$$P ( {Z}_{j} \vert {Z}_{i} ) = \frac{max ( {W}_{ij}^{decayed} , 0 ) + α}{{\sum }_{{Z}_{k} ∈ N ( {Z}_{i} )} ( max ( {W}_{ij}^{decayed} , 0 ) + α )}$$

where α is a smoothing constant (e.g., α=0.01).

### D. Structural Edge Persistence

Importantly, the edges themselves (i.e., the adjacency structure of the graph) are not subject to decay. Once an edge Zᵢ→Zⱼ has been observed, it remains in the graph permanently (or until manually removed via a management interface). Only the edge weights decay, ensuring that the graph topology remains stable while behavioral preferences adapt.

This design ensures that the system can recognize rare but valid transitions (e.g., “Kitchen to Garage” for taking out trash) even if they occur infrequently, while still adapting to changing routines (e.g., user stops using a particular path). The structural persistence also prevents the graph from “forgetting” the home's physical layout, which would require re-learning from scratch.

Even if

$${W}_{i j}^{d e c a y e d} < {W}_{min} , the edge {Z}_{i} \to {Z}_{j}$$

remains in the neighbor set N(Zᵢ), preserving the learned topology and enabling rapid re-learning if the user resumes using that path.

### E. Normalization and Probability Computation

After applying lazy decay projection to all edges in the neighbor set, the transition probabilities are recomputed via normalization (as described in Section 7.D). This ensures that Σ_{Z}_{ₖ}_{∈N(Z}_{ᵢ}₎P(Zₖ|Zᵢ)=1 at all times, even as individual edge weights decay at different rates based on their last update times.

### 5. Extrema-Preserving Keypoint Encoding (EPKE)

### A. Motivation: Bandwidth Reduction and Feature Extraction

In a distributed AI system using low-power wireless protocols (e.g., Bluetooth Mesh, Thread), available bandwidth is limited. Transmitting full-resolution sensor waveforms (e.g., 100 samples/sec PIR data) would quickly saturate the network. Additionally, raw PIR waveforms contain high-frequency noise that degrades predictive model accuracy. To address both challenges, the system employs Extrema-Preserving Keypoint Encoding (EPKE), a compressed parametric encoding scheme that serves dual technical purposes:
1. Bandwidth Reduction: By representing waveforms using keypoints instead of full sample streams, the system achieves 40:1 to 100:1 compression ratios suitable for mesh network transmission.
2. Noise Filtering and Feature Extraction: The keypoint representation preserves motion-relevant signal structures (extrema and slope changes corresponding to human movement timescales) while discarding sensor noise that would otherwise reduce pattern recognition performance. Features can be computed directly from keypoints without waveform reconstruction, enabling efficient pattern matching.

### B. Signal Processing Pipeline

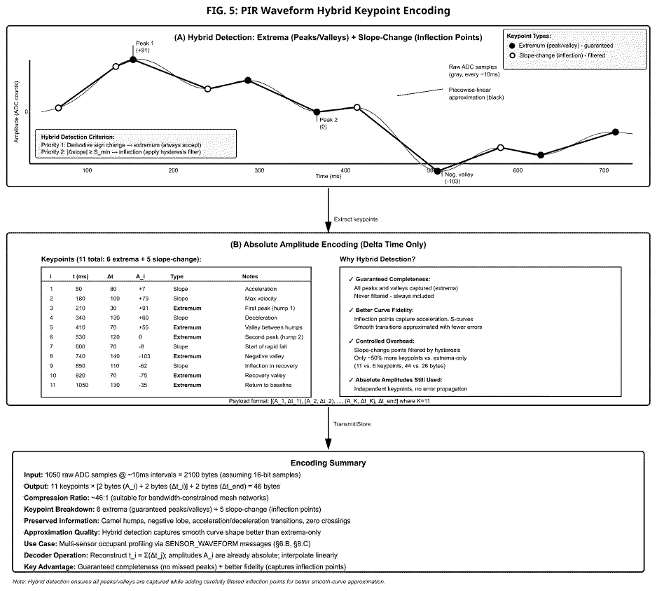

As shown in FIG. 5, the EPKE pipeline consists of the following stages:
1. Baseline Detrending (FIG. 5A): The node subtracts a slow-moving baseline from the raw PIR waveform to remove low-frequency drift and ambient temperature changes. The baseline is computed using a gated exponential moving average (EMA) that tracks the DC level while rejecting motion events, typically with a time constant of 10-30 seconds.
2. Extrema-Preserving Keypoint Extraction (FIG. 5B): The node identifies two categories of keypoints in the detrended waveform:
   Priority 1—Guaranteed Extrema: All local maxima (peaks) and minima (valleys) are detected by identifying zero-crossings in the first derivative (sign changes in the discrete difference d[n]=s[n]−[n−1]). A local maximum occurs when d[n−1]>0 and d[n]≤0; a local minimum occurs when d[n−1]<0 and d[n]≥0. These extrema capture the essential envelope shape and are always included as keypoints.
   Priority 2—Slope-Change Points (Optional): Inflection points where acceleration or deceleration changes significantly are detected by thresholding the second difference Δd[n]=d[n]−d[n−1]. When |Δd[n]|≥Sₘᵢₙ (where Sₘᵢₙ is a configurable slope-change threshold), the point is considered a candidate keypoint. Slope-change points are accepted only if they satisfy minimum separation and minimum amplitude swing hysteresis filters to prevent spurious detections from noise.
   Each keypoint is tagged with a type field: T=0 for extrema (peaks/valleys), T=1 for slope-change points. This dual-priority approach ensures that critical motion events (extrema) are never missed while optionally preserving person-specific movement signatures (gait characteristics, acceleration patterns) when bandwidth permits.
3. Absolute Amplitude and Delta Time Encoding (FIG. 5C): Unlike traditional delta encoding schemes, EPKE uses absolute amplitudes with delta-encoded times to prevent error propagation. Each keypoint is encoded as:
   Aᵢ: Absolute baseline-referenced amplitude (signed integer, e.g., Aᵢ=x[nᵢ]−2048 for a 12-bit ADC)
   Δtᵢ=tᵢ−tᵢ₋₁: Time since previous keypoint (in sample counts or milliseconds)
   The payload format is [T₁, A₁, Δt₁, T₂, A₂, Δt₂, . . . , T_{K}, A_{K}, Δt_{K}, Δt_{end}], where Δt_{end} is the trailing idle time after the last keypoint to the event endpoint. Because amplitudes are absolute rather than delta-encoded, a single corrupted packet does not cause cascading reconstruction errors—each keypoint can be decoded independently.
   In some embodiments, the type field Tᵢ may be omitted to further reduce payload size when slope-change points are not used (extrema-only mode), yielding the simplified format [A₁, Δt₁, A₂, Δt₂, . . . , A_{K}, Δt_{K}, Δt_{end}].
4. Direct Feature Extraction and Optional Reconstruction (FIG. 5D): The receiving node (or the same node, when computing features) extracts motion features directly from the keypoint representation without reconstruction. This direct computation is the primary operational mode and offers significant computational advantages over reconstructing the full waveform. Key features include:
   Waveform Energy:

$${E}_{wave} = {\sum }_{i = 1}^{K} \vert {A}_{i} \vert$$

(sum of absolute amplitudes)
Direction-of-Travel (Asymmetry):

$$D = \frac{{\sum }_{i} {A}_{i}^{+} - {\sum }_{i} {A}_{i}^{-}}{{\sum }_{i} \vert {A}_{i} \vert} ,$$

where

$${A}_{i}^{+}$$

denotes positive amplitudes (rising edges) and

$${A}_{i}^{-}$$

denotes negative amplitudes (falling edges). A positive D indicates approach; negative D indicates departure.
Event Duration:

$${T}_{total} = {\sum }_{i = 1}^{K} Δ {t}_{i} + Δ {t}_{end}$$

Peak Amplitude and Timing: The maximum amplitude and its timestamp are extracted directly from extrema keypoints (where Tᵢ=0): Aₚₑₐₖ=max{Aᵢ:Tᵢ=0} and the corresponding tₚₑₐₖ.
Valley Amplitude and Timing: The minimum amplitude and its timestamp: A_{valley}=min{Aᵢ:Tᵢ=0} and corresponding t_{valley}.
Keypoint Density: ρ=K/Tₜₒₜₐₗ (keypoints per unit time, indicating motion complexity-simple walk-through has low density, complex movements like bend-down-stand-up have high density).
Slope-Change Proportion:

$${p}_{slope} = \frac{{\sum }_{i} \text{?} ( {T}_{i} = 1 )}{K}$$

(fraction of keypoints that are slope-change points, providing a measure of acceleration/deceleration activity).
Rise Time/Fall Time: Time intervals between specific extrema sequences (e.g., first positive extremum to peak, peak to first negative extremum).
Axis Crossings: Number of sign changes in the amplitude sequence, indicating multi-phase movement patterns.
These features are used directly as inputs to the inference layer in all embodiments (Sections 5-10) and as components of the observation vector oₜ in the Reinforcement Learning embodiment (Section 10.B). Waveform reconstruction is not required for normal operation.
Optionally, for visualization, debugging, or time-domain queries requiring amplitude values at specific timestamps (e.g., forensic analysis or detailed pattern inspection), the waveform may be reconstructed by linearly interpolating between keypoints. Given keypoints (tᵢ, Aᵢ), the amplitude at any query time t∈[t₁, tᵢ₊₁] is computed as:

$$A ( t ) = {A}_{i} + \frac{{A}_{i + 1} - {A}_{i}}{{t}_{i + 1} - {t}_{i}} ( t - {t}_{i} )$$

This piecewise-linear reconstruction provides a continuous-time approximation of the original waveform shape for analysis purposes, but is typically bypassed in real-time operation in favor of direct feature extraction.

### C. Method Selection and Compression Performance

The system may employ two variants of EPKE:
Extrema-Only Mode: Captures only peaks and valleys (guaranteed extrema). Achieves maximum compression (60:1 to 100:1) and is suitable for simple binary occupancy detection and basic Markov transition models. This mode is appropriate when bandwidth is severely constrained or when person-specific pattern recognition is not required.
Hybrid Mode (Recommended): Captures guaranteed extrema plus significant slope-change points. Achieves 40:1 to 60:1 compression (typically 3-5 additional keypoints per event compared to extrema-only) and preserves person-specific movement signatures. This mode enables personalized automation, reinforcement learning with individual preference adaptation, and multi-phase movement detection (e.g., walk-pause-walk, bend-down-stand-up).

The hybrid mode is a strict superset of extrema-only: if the slope-change threshold Sₘᵢₙ is set very high, the hybrid detector degrades gracefully to extrema-only behavior.

### D. Packet Structure

The compressed waveform is transmitted as a WAVEFORM_UPDATE message (a type of Ordered Control Message, Section 3.B) containing:
Node ID: The originating node.
Sensor Index: Which sensor produced this waveform (e.g., PIR sensor 1, PIR sensor 2).
Event Start Timestamp: The absolute timestamp of the event start (milliseconds since epoch or monotonic clock).
Keypoint Array: The encoded keypoint sequence [T₁,A₁,Δt₁, . . . , T_{K},A_{K},Δt_{K},Δt_{end}] (or the simplified format without type fields in extrema-only mode).
Metadata (Optional): Pre-computed features for immediate pattern matching without decoding: total energy E_{wave}, asymmetry D, event duration Tₜₒₜₐₗ, peak amplitude Aₚₑₐₖ, or other derived features.

### E. Computational Advantages of Direct Feature Extraction

By computing features directly from keypoints rather than reconstructing the full waveform, the system achieves several performance benefits:
1. Reduced Computational Load: No interpolation or signal reconstruction required; features are simple arithmetic operations on the keypoint array.
2. Lower Memory Footprint: The receiving node stores only the compact keypoint array (3K values for hybrid mode with type field, 2K values for extrema-only mode) rather than a full sample buffer (hundreds of samples).
3. Deterministic Execution Time: Direct feature extraction has constant-time complexity O(K) with predictable memory access patterns, suitable for real-time embedded systems.
4. Numerical Stability: Absolute amplitudes eliminate error accumulation from delta decoding; features computed from these robust values are less susceptible to noise amplification.

These computational advantages make EPKE particularly well-suited for resource-constrained embedded processors (e.g., ARM Cortex-M series) common in distributed IoT deployments.

### 6. Directional Sensing and Local Intent Signals

### A. PIR Asymmetry for Direction-of-Travel

Passive infrared (PIR) sensors exhibit asymmetric responses depending on the direction of motion relative to the sensor. In one embodiment, the node computes a directional indicator D from the PIR waveform:

$$D = \frac{{\sum }_{k} Δ {A}_{k}^{+} - {\sum }_{k} Δ {A}_{k}^{-}}{{\sum }_{k} \vert Δ {A}_{k} \vert}$$

where

$$Δ {A}_{k}^{+}$$

denotes positive (low-to-high) deltas and

$$Δ {A}_{k}^{-}$$

denotes negative (high-to-low) deltas. A positive D indicates approach, while a negative D indicates departure.

### B. Proximity Sensing for Local Intent

Nodes may optionally include capacitive proximity sensors or time-of-flight (ToF) sensors that estimate the distance to a nearby occupant. As the user approaches a switch, the proximity signal increases, providing a “local intent” indicator. The system may gate automated actuation based on proximity:
Near-Switch Suppression: If the user is very close to the switch (proximity above a high threshold), the system may suppress automated actuation, assuming the user intends to manually control the load.
Proximity-Boosted Confidence: If the user is approaching (proximity increasing) but not yet at the switch, the system may boost the confidence score for turning on the load.
   C. mmWave Radar (Optional)

Nodes may optionally include millimeter-wave (mmWave) radar sensors that provide:
Range Bins: Distance estimates to detected objects.
Doppler Shift: Velocity estimates indicating approach or departure.
Micro-Motion Detection: Ability to detect stationary but breathing occupants (useful for preventing false “vacant” determinations).

### D. Computer Vision and Image-Based Occupancy Detection (Optional)

Nodes may optionally include image sensors (cameras) coupled with edge-based computer vision processing for enhanced occupancy detection, gesture recognition, and directional inference. To preserve user privacy, image processing is performed locally at the node using lightweight convolutional neural networks or classical computer vision algorithms, with only derived features (not raw images or video streams) transmitted over the mesh network.

Computer vision capabilities may include:
Occupancy Detection and Person Counting: Detecting presence and counting the number of occupants in the field of view, enabling multi-occupant tracking and load-appropriate actuation (e.g., higher brightness when multiple people are present).
Direction-of-Travel and Trajectory Prediction: Analyzing optical flow or pose sequences to determine whether an occupant is approaching or departing, complementing or replacing PIR asymmetry analysis (Section 6.A).
Gesture Recognition: Detecting hand gestures or body poses that serve as explicit control signals (e.g., wave to turn on, hand-up to increase brightness), providing non-contact interaction alternatives to physical buttons.
Gait and Posture Analysis: Extracting movement signatures that may be used for occupant-specific personalization (similar to waveform-based profiling in Section 8.C) or for detecting anomalous conditions (e.g., fall detection, medical alert scenarios).
Ambient Context: Detecting scene characteristics such as open/closed doors, furniture occlusion, or clothing type (e.g., person wearing coat suggests imminent departure) to provide additional contextual features for predictive models.

Privacy-Preserving Implementation: To address privacy concerns inherent in camera-based sensing:
Edge Processing Only: All image analysis is performed locally on the node's processor; raw images are never stored persistently or transmitted over the network.
Feature Extraction and Anonymization: Only anonymized, derived features (e.g., bounding box coordinates, occupancy count, trajectory vectors, gesture classification labels) are extracted and optionally shared with neighboring nodes.
User Control and Transparency: Computer vision functionality may be disabled via physical switch, software configuration, or time-based schedules (e.g., disabled during nighttime or in sensitive zones such as bedrooms and bathrooms).
Indicator Feedback: Nodes with active cameras may illuminate a dedicated LED indicator to signal that image capture is occurring, providing visual transparency to occupants.

Computational Considerations: Image processing is computationally intensive compared to PIR or proximity sensing. Nodes implementing computer vision may employ:
Low-Resolution Processing: Processing images at reduced resolution (e.g., 320×240 or lower) sufficient for occupancy detection and gesture recognition while minimizing computational load.
Frame Rate Reduction: Analyzing images at 1-5 fps rather than full video frame rates, adequate for human movement timescales.
Hardware Acceleration: Utilizing dedicated hardware accelerators (e.g., neural network coprocessors, GPU, or FPGA) for efficient inference.
Selective Activation: Activating camera processing only when triggered by other sensors (e.g., PIR motion) to conserve power.

Computer vision features extracted at a node may be incorporated into the observation vector oₜ in the reinforcement learning embodiment (Section 10.B), used as emission probabilities in the HMM embodiment (Section 9.B), or used to augment transition confidence in the Markov embodiments (Sections 7, 8).

### 7. Preferred Embodiment: Probabilistic State Machine

### A. Predictive State Machine Architecture

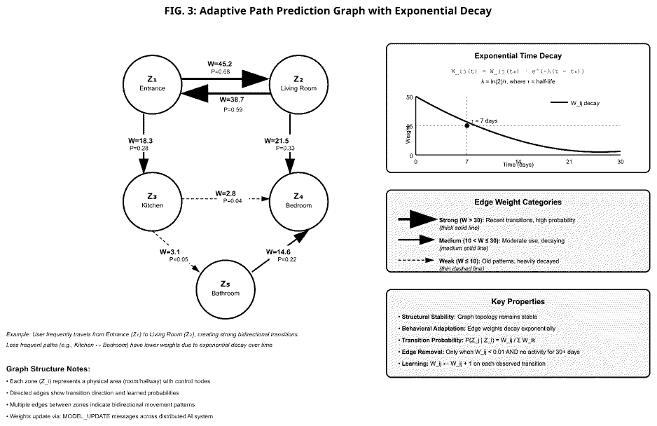

In the preferred embodiment, each control node executes a Probabilistic State Machine that models the user's environment as a directed graph of Zones connected by transition edges. As shown in FIG. 3, Zones represent logical areas (e.g., rooms or hallways), and edges represent observed user transitions from one Zone to another.

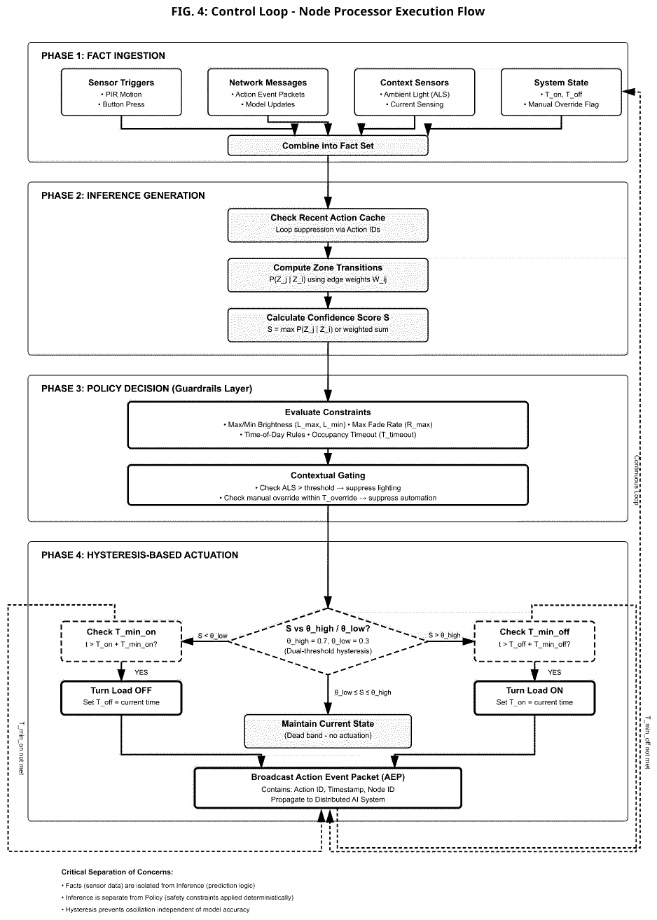

The state machine operates in a continuous loop, as illustrated in FIG. 4:
1. Fact Ingestion: The node receives sensor triggers (e.g., PIR motion, button press) and incoming network messages (e.g., AEPs, Model Updates).
2. Inference Generation: The node computes transition probabilities, predicts the user's next Zone, and calculates a Confidence Score.
3. Policy Decision: The Policy Layer maps Inferences to candidate actions, applying Guardrails and constraints
4. Hysteresis and Actuation: The node decides whether to execute the action based on dual-threshold hysteresis and minimum dwell times.
5. Action Broadcast: If an action is executed, the node broadcasts an AEP to the distributed AI system.

### B. Zone Graph Representation

The Zone graph is represented as an adjacency structure. In one embodiment, each node stores:
A list of known Zones {Z₁, Z₂, . . . , Z_{M}}.
For each Zone Zᵢ, a list of neighboring Zones N(Zᵢ) (i.e., Zones reachable from Zᵢ via a single transition).
For each directed edge Zᵢ→Zⱼ, a transition weight Wᵢⱼ (a non-negative real number representing the cumulative count of observed transitions, subject to exponential decay as described in Section 4).

The graph structure may be manually configured via a commissioning interface, automatically inferred from sensor co-occurrence patterns, or a hybrid of both.

### C. First-Order Markov Assumption

The preferred embodiment assumes that the user's next Zone depends only on the current Zone (first-order Markov property):

$$P ( {Z}_{t + 1} = {Z}_{j} \vert {Z}_{0} , {Z}_{1} , ... , {Z}_{t} ) \approx P ( {Z}_{t + 1} = {Z}_{j} \vert {Z}_{t} = {Z}_{i} )$$

This simplification enables efficient computation and storage while capturing the majority of user movement patterns in typical residential environments.

### D. Transition Probability Calculation

Given the current Zone Zᵢ, the probability of transitioning to a neighboring Zone Zⱼ∈N(Zᵢ) is computed via normalization:

$$P ( {Z}_{j} \vert {Z}_{i} ) = \frac{{W}_{ij}}{{\sum }_{{Z}_{k} ∈ N ( {Z}_{i} )} {W}_{ik}}$$

where Wᵢⱼ denotes the decayed transition weight for edge Zᵢ→Zⱼ at the time of probability computation. Specifically, Wᵢⱼ in this formula refers to

$${W}_{ij}^{decayed} ( {t}_{now} )$$

as computed via the lazy projection procedure described in Section 4.B. If Wᵢⱼ=0 (no observed transitions), the edge is effectively inactive (probability zero). To prevent zero probabilities, a small additive smoothing constant (e.g., Laplace smoothing with α=0.01) may be applied:

$$P ( {Z}_{j} \vert {Z}_{i} ) = \frac{{W}_{ij} + α}{{\sum }_{{Z}_{k} ∈ N ( {Z}_{i} )} ( {W}_{ik} + α )}$$

### E. Dual-Threshold Hysteresis

To prevent rapid oscillation between ON and OFF states, the system employs dual-threshold hysteresis on the Confidence Score S. As shown in FIG. 4, the node maintains two thresholds:
θ_{high}: The Confidence Score required to turn a load ON (or increase brightness).
θ_{low}: The Confidence Score below which a load is turned OFF (or decreased).

Typically, θ_{high}>θ_{low} (e.g., θ_{high}=0.7, θ_{low}=0.3). The system transitions between states only when S crosses these thresholds, introducing a “dead band” that prevents thrashing.

Additionally, the system enforces minimum dwell times T_{min_on} and T_{min_off} to prevent rapid toggling:
Rule: If a load was turned ON at time Tₒₙ, it cannot be turned OFF until t>Tₒₙ+T_{min_on}.
Rule: If a load was turned OFF at time T_{off}, it cannot be turned ON until t>T_{off}+T_{min_off}.

### F. Predictive Look-Ahead

The predictive look-ahead algorithm anticipates the user's next Zone (or Zones) before they arrive. In a basic embodiment (single-step look-ahead), given the current Zone Zᵢ and the transition probabilities P(Zⱼ| Zᵢ), the node computes a Confidence Score for each immediate downstream Zone:

$${S}_{j}^{( 1 )} = P ( {Z}_{j} \vert {Z}_{i} )$$

If

$${S}_{j}^{( 1 )} > {θ}_{high}$$

for some zone Zⱼ, the node controlling Zone Zⱼ (or the Runtime Actuation Authority for that Zone) may pre-emptively actuate loads (e.g., turn on lights before the user enters the room).

Multi-Step Look-Ahead (Optional Embodiment): The system may extend look-ahead to multiple steps, predicting not just the immediate next Zone but also subsequent Zones along likely paths.

Example: Consider a user currently in the Kitchen (Zone Zᵢ). For 2-step look-ahead to the Bedroom (Zone Zₘ), the system identifies all possible 2-step paths:—Path 1: Kitchen→Hallway→Bedroom—Path 2: Kitchen→Living Room→Bedroom (less common)

For each path, the system multiplies the transition probabilities along that path:—Path 1 probability: P(Hallway|Kitchen)×P(Bedroom|Hallway)—Path 2 probability: P(Living Room|Kitchen)×P(Bedroom|Living Room)

The total confidence is the sum of all path probabilities, representing the likelihood of reaching the Bedroom within 2 steps via any route.

General Formulation: The k-step look-ahead confidence for Zone Zₘ is computed by summing over all k-step paths from the current Zone Zᵢ to Zₘ:

$${S}_{m}^{( k )} = {\sum }_{paths p : {Z}_{i} \to {Z}_{m} of length k} {\prod }_{( {Z}_{a} , {Z}_{b} ) ∈ p} P ( {Z}_{b} \vert {Z}_{a} )$$

where:—The outer sum (Σ) adds up the probabilities of all distinct paths—Each path p consists of exactly k edges (transitions between zones)—The inner product (Π) multiplies the transition probabilities along a single path—(Zₐ, Z_{b}) represents each edge in the path

For 2-step look-ahead specifically, this simplifies to:

$${S}_{m}^{( 2 )} = {\sum }_{{Z}_{j} ∈ N ( {Z}_{i} )} P ( {Z}_{j} \vert {Z}_{i} ) \cdot P ( {Z}_{m} \vert {Z}_{j} )$$

where the sum is over all intermediate Zones Zⱼ reachable from Zᵢ (the neighbor set N(Zᵢ)). This means: “for each zone we might visit next, multiply the probability of going there by the probability of then going to Zₘ, and add all these possibilities together.”

In practice, the system may limit look-ahead to k=2 or k=3 steps to balance prediction utility against computational cost. Multi-step look-ahead enables pre-actuation of deeper downstream Zones (e.g., turning on bathroom lights when the user enters the bedroom, if the bedroom-to-bathroom transition is highly probable).

To avoid false positives and excessive pre-actuation, the system may further gate predictions using contextual signals (e.g., time of day, ambient light level, Zone Profile, or recent user activity). For example:
If ambient light is already high, predictive lighting may be suppressed.
If the user has been stationary in Zᵢ for an extended period, the prediction confidence may be reduced.
Multi-step look-ahead may be enabled only for high-probability primary paths

$$( e . g . , {S}_{j}^{( 1 )} > 0.5 ) \qquad ( 1 )$$

to avoid actuating rarely-used zones.
Zone Profiles may modulate actuation behavior: hallways may prioritize immediate path lighting (low confidence threshold), while closets or pantries may require higher confidence to avoid unnecessary actuation.

### G. Deterministic Policy Layer (Guardrails)

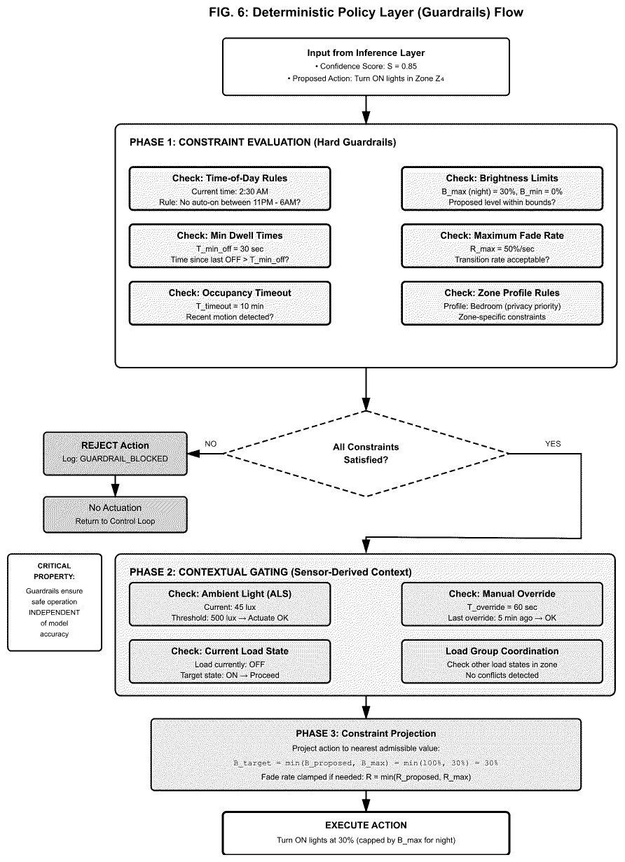

As shown in FIG. 6, even when the Inference Layer generates a high-confidence prediction, the system does not actuate blindly. Instead, the Deterministic Policy Layer (“Guardrails Layer”) applies a set of hard constraints and contextual rules to ensure safety, comfort, and user experience. This layer operates as follows:

Constraint Evaluation: The node evaluates each proposed action against configured constraints and current load states. Examples include:
Load Group Coordination: If Node A's “soft lighting” loads are active, reduce confidence for Node B's “task lighting” automation unless ambient light is insufficient
Mutual Exclusivity Rules: If Load Group X is manually activated, suppress automated actuation of Load Group Y for duration T
Maximum Brightness: Bₘₐₓ (e.g., 100% during day, 30% at night).
Minimum Brightness: Bₘᵢₙ (e.g., 0% or 5% nightlight level).
Maximum Fade Rate: Rₘₐₓ (e.g., 50% per second) to avoid jarring transitions.
Minimum On/Off Dwell: T_{min_on}, T_{min_off} as described in Section 7.E.
Occupancy Timeout: Tₜᵢₘₑₒᵤₜ (e.g., turn off after 10 minutes of no detected motion).
Time-of-Day Rules: Different brightness caps or disabling of predictive actions during certain hours (e.g., “do not auto-on between 11 PM and 6 AM”).
Zone Profile-Specific Rules: Constraints may vary by Zone Profile. For example, bedrooms may enforce stricter nighttime brightness limits (e.g., Bₘₐₓ=10% after 10 PM), bathrooms may allow brighter levels and faster actuation for safety, hallways may prioritize immediate path lighting, and closets/pantries may have longer occupancy timeouts before auto-off.
Futile Actuation Suppression (Optional): If load current sensing is available, the system detects failed actuations (e.g., commanding ON but measuring no current draw, indicating a burned-out bulb or unplugged lamp). After detecting N_{fail} consecutive failures (e.g., N_{fail}=3), the system marks the load as non-functional and suppresses further automated actuation attempts until a successful manual actuation or current draw is detected. This prevents wasted effort and avoids repeated futile commands.
2. Constraint Projection: If the proposed action violates one or more constraints, the system projects it to the nearest admissible action. For example:
   If the proposed brightness is 120% (violating Bₘₐₓ=100%), it is clamped to 100%.
   If the proposed fade rate is 80%/sec (violating Rₘₐₓ=50%/sec), it is reduced to 50%/sec.
3. Action Selection: The constrained action is passed to the actuation layer. If no admissible action exists (e.g., all constraints reject the action), the system defaults to a safe fallback (e.g., no actuation, or a minimal nightlight level).

This Guardrails Layer ensures that the system cannot produce obnoxious or unsafe automation, even if the Inference Layer generates incorrect predictions.

### H. Zone Profile Learning and Adaptation

Zone Profiles may be automatically inferred or updated based on observed usage patterns rather than relying solely on static commissioning. For example:
A room initially configured as “Living Room” may be reclassified to “Home Office” if weekday daytime sensor patterns consistently show single-occupant stationary presence with extended dwell times.
Constraint parameters (e.g., brightness caps, timeout durations) may be personalized per-zone based on observed manual correction patterns in the RL embodiment (Section 10).
Seasonal or time-based profile switching may occur automatically (e.g., a “Guest Bedroom” profile activates when occupancy sensors detect multi-day presence patterns inconsistent with primary household members).
Time-of-day sub-profiles may be learned (e.g., “Kitchen-Morning” with bright task lighting preferences vs. “Kitchen-Evening” with dimmer ambient preferences).

The system may maintain a confidence score for each Zone Profile assignment and trigger re-evaluation when observed patterns diverge from expected profile characteristics. Profile adaptation may be gated by a stability threshold to prevent spurious reclassification from transient behavioral changes.

This dynamic profile adaptation distinguishes the system from static commissioning frameworks where zone classifications and associated behaviors are fixed at installation time. The combination of Zone Profile conditioning with predictive look-ahead (Section 7.F), constraint modulation (Section 7.G), and learned transition probabilities (Section 4) enables context-aware automation that evolves with household usage patterns.

### 8. First Alternative Embodiment: Variable-Order Markov

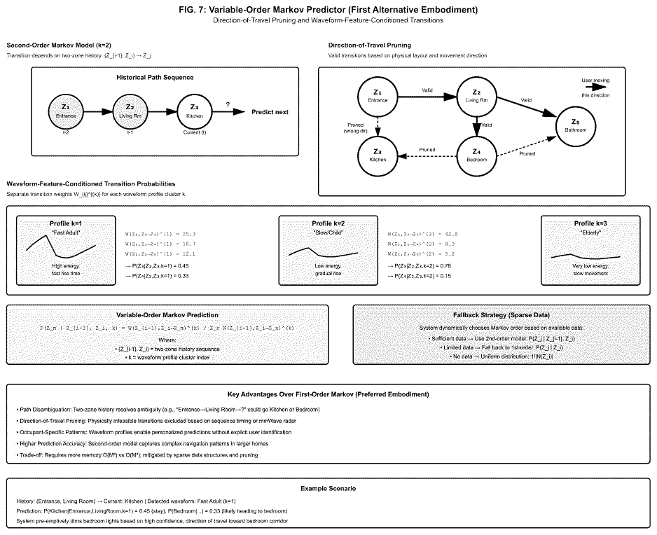

As shown in FIG. 7, in a first alternative embodiment, the system extends the preferred embodiment's first-order Markov model to a variable-order Markov model, incorporating second-order (or higher-order) transition probabilities, direction-of-travel, and waveform-based occupant profiling. This embodiment utilizes the same distributed Causal Action Protocol (Section 3), Distributed Consistency mechanisms (Section 1), Waveform Processing (Section 5), and Deterministic Policy Layer (Section 7.G) as the preferred embodiment, but replaces the first-order transition probability calculation with a more sophisticated graph traversal algorithm.

### A. Second-Order Markov Transitions

In this embodiment, the system maintains transition weights W(Zᵢ₋₁, Zᵢ→Zⱼ) conditioned on both the current Zone Zᵢ and the previous Zone Zᵢ₋₁. The transition probability is computed as:

$$P ( {Z}_{j} \vert {Z}_{i} , {Z}_{i - 1} ) = \frac{W ( {Z}_{i - 1} , {Z}_{i} \to {Z}_{j} )}{{\sum }_{{Z}_{k} ∈ N ( {Z}_{i} )} W ( {Z}_{i - 1} , {Z}_{i} \to {Z}_{k} )}$$

This captures path-dependent behavior. For example, if a user typically goes Kitchen→Hallway→Bedroom but not Kitchen→Hallway→Living Room, the second-order model can represent this distinction.

### B. Fallback to Lower-Order Models

To handle sparse data (e.g., an observed transition path that has never been seen before), the system implements a fallback strategy:
1. Attempt to use the second-order model: P(Zⱼ|Zᵢ, Zᵢ₋₁).
2. If insufficient data exists (e.g., ΣₖW(Zᵢ₋₁, Zᵢ→Zₖ)<θₘᵢₙ), fall back to the first-order model: P(Zⱼ|Zᵢ).
3. If the first-order model also lacks data, use a uniform distribution over neighbors:

$$P ( {Z}_{j} \vert {Z}_{i} ) = \frac{1}{\vert N ( {Z}_{i} ) \vert} .$$

This hierarchical fallback ensures graceful degradation in prediction quality when encountering novel or rarely-observed transition sequences, preventing prediction failures while allowing the system to learn from new data as it accumulates.

### C. Waveform-Based Occupant Profiles

Because the encoded PIR waveform (described in Section 5) carries occupant-distinct features, the system may compute a low-dimensional feature signature φ directly from the keypoint representation (e.g., energy, asymmetry, keypoint spacing statistics, and slope-change proportion). The predictor may maintain multiple edge-weight profiles indexed by coarse feature clusters. By maintaining separate transition weights

$${W}_{i j}^{( k )}$$

for different clusters k (derived from φ), the system enables the calculation of P(Z|Zᵢ, k). This allows the system to exhibit “per-occupant-like” personalization and prediction without requiring the storage of explicit user identities or facial recognition.

### 9. Second Alternative Embodiment: Hidden Markov Model/Dynamic Bayesian Network

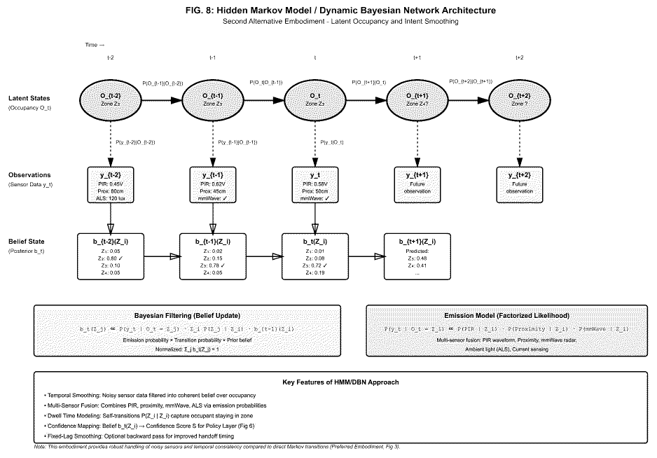

As shown in FIG. 8, in a second alternative embodiment, the system converts noisy, asynchronous sensor observations into a coherent, time-consistent belief over occupant location and near-term intent. This embodiment leverages the same distributed AI Architecture and Autonomous Coordination (Section 1), Distributed Consistency mechanisms (Section 2), Waveform Processing (Section 5), and Deterministic Policy Layer (Section 7.G) as the preferred embodiment, but replaces the direct Markov transition probability calculation with a probabilistic inference framework using Hidden Markov Models or Dynamic Bayesian Networks.

### A. Time Steps and Latent State Definition

The model operates over a sequence of time steps t. The system supports three time-stepping modes:
(i) Event-Driven: The time step index t represents the t-th observation event, where updates occur only when sensor data arrives.
(ii) Fixed-Interval: Updates occur at regular time intervals Δt (e.g., every 100 ms), with t representing elapsed time in units of Δt.
(iii) Adaptive-Interval: Updates occur at irregular intervals Δt corresponding to sensor events, where transition probabilities are adjusted as a function of elapsed time between events (e.g., self-transition probability P(Zᵢ|Zᵢ) decreases as Δt increases, reflecting lower certainty about continued occupancy after longer gaps).

The system models a latent occupancy state variable Oₜ where Oₜ∈{Z₁, Z₂, . . . }. The node maintains a belief distribution:

$${b}_{t} ( {Z}_{i} ) = P ( {O}_{t} = {Z}_{i} \vert {y}_{1 : t} )$$

where y_{1:t} denotes the sequence of observations up to time t. Optionally, the model includes a latent intent variable Iₜ (e.g., “heading toward Zone Zₖ”), forming a DBN.

### B. Observation Vector and Sensor Emissions

At time t, the system forms an observation vector yₜ from available sensor inputs. The emission model P(yₜl|Oₜ) may be implemented using any suitable classifier (e.g., Factorized Likelihood). The observation vector may include one or more of the following sensor-derived features:
PIR waveform features: Motion signatures derived from the parametric/keypoint encoding described in Section 5, including energy, asymmetry, and temporal characteristics.
Proximity: Distance-to-switch estimate from capacitive or time-of-flight sensors (Local Intent Signal), useful for detecting user approach and gating automated actions.
Ambient Light and IR: Visible and infrared illumination levels used to determine whether additional lighting is needed and to gate lighting actions based on natural light availability.
Load Current Sensing: Measured current draw through the connected load, used to confirm successful actuation (detecting burned-out bulbs or unplugged devices), monitor actual power consumption, and provide feedback on load state for belief updates.
Other Sensor Inputs: Additional sensor modalities such as mmWave radar (range, micro-motion, direction-of-travel), button/touch inputs (manual interaction events), acoustic sensors, or network context from neighboring nodes may be incorporated as available.
Computer Vision Features (Optional): Image-derived features including occupancy count, bounding box trajectories, detected gestures, and directional flow vectors extracted via edge-based computer vision processing (Section 6.D).

### Example Factorized Likelihood:

$$P ( {y}_{t} \vert {O}_{t} = {Z}_{i} ) ∝ P ( PIR \vert {Z}_{i} ) \cdot P ( Proximity \vert {Z}_{i} ) \cdot P ( Ambient / IR \vert {Z}_{i} ) \cdot P ( Current \vert {Z}_{i} )$$

where each factor represents the likelihood of observing the respective sensor reading given occupancy state Zᵢ.

### C. Transition Model and Dwell Time

The occupancy transition model uses the learned Zone graph transition probabilities. To account for users remaining in a zone, the model explicitly includes self-transition probabilities (dwell time):

$$P ( {O}_{t} = {Z}_{j} \vert {O}_{t - 1} = {Z}_{i} ) = P ( {Z}_{j} \vert {Z}_{i} )$$

where P(Zᵢ|Zᵢ) represents the probability of staying in Zone Zᵢ. The self-loop Zᵢ→Zᵢ may be treated as a valid transition within the neighbor set N(Zᵢ) for normalization purposes.

The self-transition probability P(Zᵢ|Zᵢ) may be initialized with a default value (e.g., 0.7-0.9) to model typical dwell persistence, learned from observed dwell-time statistics, or adjusted based on zone characteristics (e.g., hallways have lower self-transition probabilities than living rooms, reflecting their transient nature).

### D. Online Filtering and Smoothing

Upon receiving new sensor evidence, the node updates the belief distribution using a Bayesian filtering step:

$${b}_{t} ( {Z}_{j} ) ∝ P ( {y}_{t} \vert {O}_{t} = {Z}_{j} ) \cdot {\sum }_{{Z}_{i}} P ( {Z}_{j} \vert {Z}_{i} ) {b}_{t - 1} ( {Z}_{i} )$$

followed by normalization so that Σⱼbₜ(Zⱼ)=1.

To improve handoff timing, the system may apply fixed-lag smoothing. The node may store the belief states over a window of length l and re-run a backward pass to compute the smoothed estimate \hat{b}ₜ₋ₗ(Zᵢ).

### E. Unscented Kalman Filter Implementation (Optional)

In one implementation, the Bayesian filtering and belief propagation described in Section 9.D may be performed using an Unscented Kalman Filter (UKF), which provides efficient handling of the nonlinear observation model while maintaining computational tractability suitable for embedded processors.

Motivation for UKF: The observation function P(yₜ|Oₜ) is inherently nonlinear due to the parametric waveform features, proximity sensing, and multi-modal sensor fusion described in Section 9.B. Traditional Extended Kalman Filter (EKF) approaches linearize this observation function, achieving only first-order accuracy and potentially introducing significant errors in the belief distribution. The UKF addresses these limitations by using a deterministic sampling approach that achieves third-order accuracy for Gaussian distributions without requiring explicit Jacobian calculations.

Unscented Transformation: The UKF represents the belief distribution bₜ(Zᵢ) using a minimal set of carefully chosen sigma points Xᵢ (with corresponding weights Wᵢ) that completely capture the true mean and covariance of the belief distribution. For a belief distribution with dimension N (number of zones), the UKF constructs 2N+1 sigma points according to:

$${𝒳}_{0} = {\overline{b}}_{t}$$

$${𝒳}_{i} = {\overline{b}}_{t} + {( \sqrt{( L + λ ) {P}_{{b}_{t}}} )}_{i} i = 1 , … , L$$

$${𝒳}_{i} = {\overline{b}}_{t} - {( \sqrt{( L + λ ) {P}_{{b}_{t}}} )}_{i - L} i = L + 1 , … , 2 L$$

where:—b̅ₜ is the mean of the belief distribution—P_{b}_{ₜ} is the covariance matrix of the belief distribution—λ=α²(N+κ)−N is a scaling parameter—α determines the spread of sigma points (typically 10⁻³≤α≤1)—κ is a secondary scaling parameter (typically κ=0 or K=3−L)−(\sqrt{(L+λ) P_{b}_{ₜ}})ᵢ denotes the i-th column of the matrix square root (e.g., computed via Cholesky decomposition)

The weights for mean and covariance propagation are:

$${W}_{0}^{( m )} = \frac{λ}{L + λ}$$

$${W}_{0}^{( c )} = \frac{λ}{L + λ} + ( 1 - {α}^{2} + β )$$

$${W}_{i}^{( m )} = {W}_{i}^{( c )} = \frac{1}{2 ( L + λ )} i = 1 , … , 2 L$$

where β encodes prior knowledge about the distribution (β=2 is optimal for Gaussian distributions).

Prediction Step: Each sigma point is propagated through the state transition model:

$${𝒳}_{i , t \vert t - 1} = F ( {𝒳}_{i , t - 1} ) = {\sum }_{{Z}_{k}} P ( {Z}_{k} \vert {𝒳}_{i , t - 1} ) \cdot {Z}_{k}$$

where the transition applies the learned zone graph transition probabilities to each sigma point. The predicted belief mean and covariance are computed as:

$${\overline{b}}_{t \vert t - 1} = {\sum }_{i = 0}^{2 L} {W}_{i}^{( m )} {𝒳}_{i , t \vert t - 1}$$

$${P}_{{b}_{t \vert t - 1}} = {\sum }_{i = 0}^{2 L} {{W}_{i}^{( c )} [ {𝒳}_{i , t \vert t - 1} - {\overline{b}}_{t \vert t - 1} ] [ {𝒳}_{i , t \vert t - 1} - {\overline{b}}_{t \vert t - 1} ]}^{T} + {Q}_{t}$$

where Qₜ is the process noise covariance.

Measurement Update: Each predicted sigma point is transformed through the nonlinear observation model to produce predicted observations:

$${𝒴}_{i , t} = H ( {𝒳}_{i , t \vert t - 1} , {y}_{t} )$$

where H computes the expected sensor observations given occupancy state [symbol] _{i,t|t-1} and may incorporate the multi-sensor emission models (PIR waveform features from Section 5, proximity signals from Section 6, ambient/IR readings, load current, and optional mmWave features).

The predicted measurement mean and covariance are:

$${\overline{y}}_{t \vert t - 1} = {\sum }_{i = 0}^{2 L} {W}_{i}^{( m )} {𝒴}_{i , t}$$

$${P}_{{y}_{t} {y}_{t}} = {\sum }_{i = 0}^{2 L} {{W}_{i}^{( c )} [ {𝒴}_{i , t} - {\overline{y}}_{t \vert t - 1} ] [ {𝒴}_{i , t} - {\overline{y}}_{t \vert t - 1} ]}^{T} + {R}_{t}$$

where Rₜ is the measurement noise covariance matrix (capturing sensor noise characteristics).

The cross-covariance between belief state and observation is:

$${P}_{{b}_{t} {y}_{t}} = {\sum }_{i = 0}^{2 L} {{W}_{i}^{( c )} [ {𝒳}_{i , t \vert t - 1} - {\overline{b}}_{t \vert t - 1} ] [ {𝒴}_{i , t} - {\overline{y}}_{t \vert t - 1} ]}^{T}$$

The Kalman gain and belief update are computed as:

$${K}_{t} = {P}_{{b}_{t} {y}_{t}} {P}_{{y}_{t} {y}_{t}}^{- 1}$$

$${\overline{b}}_{t} = {\overline{b}}_{t \vert t - 1} + {K}_{t} ( {y}_{t} - {\overline{y}}_{t \vert t - 1} )$$

$${P}_{{b}_{t}} = {P}_{{b}_{t \vert t - 1}} - {K}_{t} {P}_{{y}_{t} {y}_{t}} {K}_{t}^{T}$$

Computational Complexity: The UKF requires 2N+1 sigma points for an L-dimensional belief space (number of zones). For a typical residential deployment with L=10 to L=20 zones, this results in 21-41 sigma points, with computational complexity O(L³) dominated by the matrix square root operation. This is comparable to the EKF and remains tractable for embedded processors (e.g., ARM Cortex-M4 at 168 MHz can perform a complete UKF update cycle in under 10 milliseconds for L=15 zones).

Multi-Sensor Fusion: The UKF naturally handles multi-sensor fusion by constructing the observation vector yₜ from heterogeneous sensor inputs as described in Section 9.B. The measurement noise covariance Rₜ may be structured as a block-diagonal matrix capturing the independence assumptions between sensor modalities:

$${R}_{t} = [ \begin{matrix}{R}_{PIR} & 0 & 0 & 0 \\ 0 & {R}_{Prox} & 0 & 0 \\ 0 & 0 & {R}_{ALS / IR} & 0 \\ 0 & 0 & 0 & {R}_{Current}\end{matrix} ]$$

or may include off-diagonal terms to model correlated sensor noise when appropriate.

Advantages Over Linearization: The UKF provides several advantages for this application:
1. Nonlinear Sensor Models: The waveform feature extraction (Section 5), directional asymmetry computation (Section 6.A), and proximity-based intent inference (Section 6.B) are inherently nonlinear. The UKF handles these transformations accurately without requiring analytical derivatives.
2. Multi-Modal Distributions: When occupancy is ambiguous (e.g., user may be in either of two adjacent zones), the sigma point representation better captures multi-modal posterior distributions than linearization approaches.
3. Numerical Stability: The UKF avoids potential instabilities from inaccurate Jacobian approximations, particularly when sensor signals are near threshold crossings or when waveform features exhibit discontinuous behavior.
4. Implementation Simplicity: No explicit Jacobian or Hessian calculations are required, simplifying implementation and reducing opportunities for analytical errors in the observation model derivatives.

The UKF implementation may be combined with the distributed belief exchange (Section 9.F) and multi-occupant tracking (Section 9.G) mechanisms, with each node running a local UKF instance and sharing belief summaries via OCCUPANCY_BELIEF packets.

### F. Action Selection and Confidence Mapping

The belief distribution is treated as an Inference input to the Policy Layer. The system maps the belief distribution to a scalar “Confidence Score” S. For example:

$$S = {max}_{i} {b}_{t} ( {Z}_{i} ) ( Confidence in the most likely zone ) .$$

$${S}_{target} = {b}_{t} ( {Z}_{k} ) ( Confidence for a specific target zone ) .$$

$${S}_{handoff} = {\sum }_{{Z}_{k} ∈ Ω} {b}_{t} ( {Z}_{k} ) ( Confidence in a downstream set ) .$$

The system selects an action by maximizing expected utility under the occupancy belief, subject to the Guardrails defined in Section 7.G.

### G. Distributed Belief Exchange

Nodes may broadcast their belief state to neighboring nodes via OCCUPANCY_BELIEF packets containing the current belief distribution bₜ(Zᵢ) for all zones or a subset of high-confidence zones. Receiving nodes may incorporate these shared beliefs as additional observations in their own inference process, enabling distributed occupancy tracking and coordinated predictions across the mesh network. To prevent inference loops where shared beliefs circularly reinforce each other, these packets are treated as observational Facts subject to the same Deduplication and Cache rules as Model Updates described in Section 3.C, ensuring that each belief update is processed only once per node.

### H. Multi-Occupant Handling

To track multiple independent occupants moving simultaneously through the environment, the latent state may be represented using a Factorial HMM structure or multiple parallel latent variables. In the Factorial HMM approach, the joint state is factored as

$${O}_{t} = ( {O}_{t}^{( 1 )} , {O}_{t}^{( 2 )} , ... , {O}_{t}^{( K )} )$$

where each

$${O}_{t}^{( k )}$$

represents the location of the k-th occupant. The belief distribution becomes a joint distribution

$${b}_{t} ( {O}_{t}^{( 1 )} , ... , {O}_{t}^{( K )} )$$

or, under independence assumptions, a product of marginal distributions

$${\prod }_{k} {b}_{t} ( {O}_{t}^{( k )} ) .$$

This structure allows the system to maintain separate occupancy estimates for each individual, enabling accurate predictions even when multiple people are present in different zones simultaneously.

### 10. Third Alternative Embodiment: Reinforcement Learning

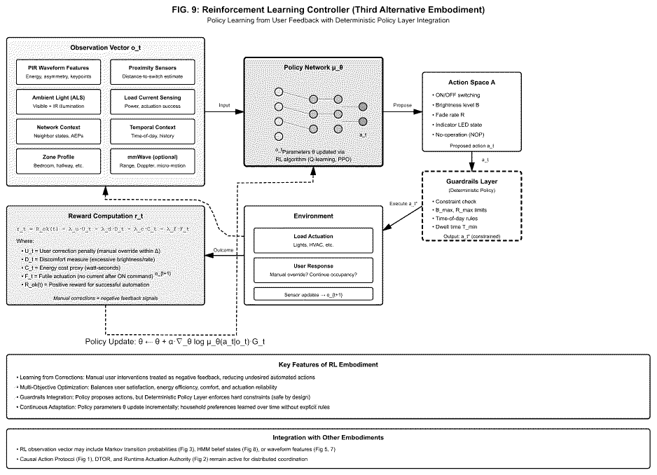

As shown in FIG. 9, in a third alternative embodiment, the system implements a Reinforcement Learning (RL) controller configured to adapt automated actuation behavior based on user feedback implicitly expressed through manual interactions. This embodiment leverages the same distributed Causal Action Protocol (Section 3), Distributed Consistency mechanisms (Section 2), Waveform Processing (Section 5), and Deterministic Policy Layer (Section 7.G) as the preferred embodiment, but replaces or augments the predictive inference layer with a learned policy that optimizes for user satisfaction, comfort, and energy efficiency.

In this embodiment, manual user interventions (e.g., physical button presses, touch, gesture, or other local override inputs) are treated as negative feedback signals, such that the RL controller learns a policy u that reduces the frequency and severity of undesired automated actions while maintaining responsiveness, comfort, and energy objectives.

### A. Sequential Decision Process Formulation

Each control node (or a controller coordinating multiple nodes within a Zone) models the environment as a sequential decision process. At decision time t, the node obtains an observation vector oₜ derived from locally sensed data and, optionally, messages received from other nodes via the distributed AI system. The node selects an action αₜ according to a policy μ, actuates the load accordingly, and subsequently receives a scalar reward rₜ that encodes the desirability of the resulting outcome.

The decision process may be formulated as a Markov Decision Process (MDP), wherein the observation oₜ is assumed to fully capture the relevant state of the environment. Alternatively, the decision process may be formulated as a Partially Observable Markov Decision Process (POMDP), wherein the node maintains an internal belief state bₜ or learned hidden state hₜ (e.g., via a recurrent neural network), updated as a function of past observations and actions. In the POMDP formulation, decisions are based on (oₜ, hₜ) rather than assuming full observability of occupant intent.

### B. Observation Vector Construction

The observation vector oₜ may comprise one or more of the following features, alone or in combination:
1. PIR Waveform Features: Features derived from the compressed parametric waveform encoding of the PIR waveform (as described in Section 5), including but not limited to: waveform energy E_{wave}=Σₖ|ΔAₖ| computed from delta-encoded amplitude changes, keypoint spacing statistics derived from time deltas Δtₖ between extrema, asymmetry ratio computed from positive versus negative amplitude deltas, and event magnitude characteristics extracted from the baseline-detrended signal.
2. Direction-of-Travel Features: A directional indicator inferred from the asymmetry of the PIR waveform encoding (the ratio of positive to negative delta magnitudes ΔAₖ as described in Section 6.A), or from mmWave radar Doppler shift analysis, indicating whether the user is approaching or departing the node.
3. Proximity Features: An estimated distance-to-switch (continuous or discretized) derived from capacitive proximity sensing, time-of-flight sensors, or mmWave range bins, and thresholded indicators (e.g., “near-switch” binary flag).
4. Ambient Light and IR Features: Visible and infrared components of ambient illumination measured by the ambient light sensor (ALS), and derived measures of illumination sufficiency (e.g., whether additional lighting is needed).
5. Load Current Features: Measured current draw through the load, inferred power consumption, detection of actuation success or failure (e.g., commanded ON but no current detected, indicating burned-out bulb or unplugged lamp), and temporal statistics such as duty cycle or cumulative energy proxy.
6. mmWave Occupancy Features (Optional): Micro-motion presence indicators, range bin energy, occupancy confidence metrics, or stationary occupant detection derived from mm Wave radar, useful for detecting low-motion conditions or distinguishing between occupied and vacant states.
7. Network Context Features (Optional): Recent trigger or event messages from other nodes, predicted path information from upstream nodes, inferred occupancy of adjacent Zones, load states of other load groups within the same Zone, recent action summaries, and Runtime Actuation Authority status.
8. Temporal Context: Time-of-day, day-of-week, or derived temporal features (e.g., “morning,” “evening,” “night”), and elapsed time since last manual interaction or last automated action.
9. Zone Profile Features: The Zone Profile identifier (e.g., bedroom, bathroom, hallway, closet, pantry, living room) encoded as a one-hot vector or categorical embedding. Zone Profile information enables the RL policy to learn location-specific behaviors, such as conservative actuation in bedrooms during nighttime, rapid path lighting in hallways, or higher brightness defaults in kitchens and bathrooms for safety.
10. Computer Vision Features (Optional): Occupancy count, trajectory vectors, gesture classification labels, gait signatures, and scene context features derived from local image processing (Section 6.D), where raw images are processed at the edge and never stored or transmitted.

The above features may be normalized (e.g., min-max scaling, z-score normalization), filtered (e.g., exponential moving average to reduce sensor noise), and/or fused to form the observation vector oₜ Observations may be aggregated over a temporal window (t−k, . . . , t) to incorporate short-term history.

### C. Action Space

The action αₜ is selected from an action space A that includes one or more of the following action types:
1. Binary Switching Actions: Turning a controllable load ON or OFF.
2. Dimming Actions: Setting a brightness level to a target value B_{target} within an allowed range [Bₘᵢₙ, Bₘₐₓ], optionally in discrete steps (e.g., 0%, 10%, 20%, . . . , 100%).
3. Transition Actions: Selecting a ramp rate R or fade duration T_{fade} used to transition from the current brightness level to the target brightness level, enabling smooth or rapid transitions as appropriate.
4. Indicator LED Actions: Setting the intensity and/or color of side indicator LEDs, including use as a nightlight indicator or status display.
5. No-Operation (NOP) Action: Explicitly taking no action, deferring actuation to a later time step, useful when confidence is low or when waiting for additional sensor evidence.

The action space may be factored or structured. For example, the policy may select a joint action (α_{on/off}, α_{dim}, α_{fade}) representing an ON/OFF decision, a target brightness, and a fade rate. Alternatively, the policy may select these components sequentially or conditionally (e.g., “if turning ON, then select brightness and fade rate”).

### D. Reward Signal and User Correction Penalties

The reward signal rₜ is configured to encourage desirable automation outcomes and discourage undesirable ones. In this embodiment, the reward includes a penalty component when the system detects that a user has manually corrected or overridden an automated action within a defined time window Δ (e.g., Δ=60 seconds).

The reward may be expressed as:

$${r}_{t} = {R}_{ok} ( t ) - {λ}_{u} \cdot {U}_{t} - {λ}_{d} \cdot {D}_{t} - {λ}_{c} \cdot {C}_{t} - {λ}_{f} \cdot {F}_{t}$$

where:
Uₜ is an indicator or magnitude of user override behavior, such as manual ON/OFF toggle, manual brightness adjustment, gesture-based override, or repeated corrections within a short window. The override measure Uₜ may be binary (e.g., Uₜ=1 if a manual correction occurred within time window Δ following an automated action, and Uₜ=0 otherwise), or may be a continuous measure of the “severity” of the correction (e.g., magnitude of brightness change, number of repeated toggles).
Dₜ is a discomfort measure, capturing excessive brightness changes, excessive ramp rates, or inappropriate actuation timing (e.g., turning on lights during configured sleep hours). The discomfort measure may be derived from configured comfort limits (as defined in the Guardrails Layer, Section 7.G) and/or inferred from patterns of user corrections.
Cₜ is an energy cost proxy, such as estimated watt-seconds or current-integrated cost, optionally computed from load current sensing. This term encourages energy-efficient operation by penalizing excessive ON time or high brightness levels when not needed.
Fₜ captures failure or “futile actuation,” such as commanding the load ON but detecting no current draw (indicating a burned-out bulb, unplugged lamp, or relay failure), or repeated toggling without achieving the desired effect. Penalizing futile actions encourages the policy to avoid wasting effort on non-functional loads.
Rₒₖ(t) is a baseline positive reward (e.g., a small constant, or a function of time-in-state) awarded when the system successfully maintains appropriate illumination without user intervention.

The weighting coefficients λᵤ, λ_{d}, λ_{c}, λ_{f}>0 are hyperparameters that balance the relative importance of avoiding user corrections, maintaining comfort, conserving energy, and preventing futile actions.

### E. Policy Representation

The policy μ_{θ}: oₜ→αₜ is parameterized by a set of learnable parameters θ. The policy may be represented as:
1. Lookup Table: For small, discrete observation and action spaces, the policy may be stored as a table mapping observation states to action probabilities or Q-values.
2. Linear Function Approximation: The policy or value function is represented as a linear combination of features: Q(o, α)=θ^{T}φ(o, α), where φ(o, α) is a feature vector derived from the observation and action.
3. Neural Network: The policy is represented as a multilayer perceptron (MLP), convolutional neural network (CNN), or recurrent neural network (RNN) with parameters θ. The network takes oₜ (and optionally hₜ₋₁) as input and outputs action probabilities μ_{θ}(α|oₜ) or action values Q_{θ}(oₜ, α).
4. Factored Policy: The policy is decomposed into independent or semi-independent sub-policies for different action components (e.g., separate networks for ON/OFF decision, brightness selection, and fade rate selection).

The policy network may be intentionally kept small and computationally lightweight (e.g., a 2-3 layer MLP with 32-128 hidden units) to enable real-time inference on resource-constrained embedded processors (e.g., ARM Cortex-M4 or equivalent).

### F. Learning Algorithm

The system updates the policy parameters θ using a reinforcement learning algorithm. The learning algorithm may be selected from:
1. Q-Learning or Deep Q-Network (DQN): The system learns an action-value function Q_{θ}(oₜ, αₜ) and selects actions greedily or using an exploration strategy (e.g., ϵ-greedy). Updates are performed using temporal difference (TD) learning:

$$θ ← θ + α [ {r}_{t} + γ {max}_{{a}^{′}} {Q}_{θ} ( {o}_{t + 1} , {a}^{′} ) - {Q}_{θ} ( {o}_{t} , {a}_{t} ) ] {∇}_{θ} {Q}_{θ} ( {o}_{t} , {a}_{t} )$$

where α is the learning rate and γ is a discount factor.
2. Policy Gradient (e.g., REINFORCE, Actor-Critic, PPO): The system directly optimizes the policy μ_{θ} to maximize expected cumulative reward. Updates are performed using the policy gradient:

$$θ ← θ + α {∇}_{θ} log {μ}_{θ} ( {a}_{t} \vert {o}_{t} ) \cdot {G}_{t}$$

where Gₜ is the return (cumulative discounted reward) or an advantage estimate.
3. Contextual Bandits: If the decision process is effectively memoryless (i.e., current observation fully determines the best action, and actions do not significantly affect future states), the system may use a contextual bandit algorithm (e.g., Thompson Sampling, UCB) to balance exploration and exploitation.
4. Model-Based RL: The system learns a model of the environment dynamics P(oₜ₊₁, rₜ|oₜ, αₜ) and uses this model to plan actions (e.g., via model-predictive control or tree search) or to generate synthetic training data for policy learning.

The learning algorithm may incorporate experience replay, where observed transitions (oₜ, αₜ, rₜ, oₜ₊₁) are stored in a replay buffer and sampled in batches to perform policy updates, improving sample efficiency and stability.

### G. Exploration Strategy

To discover effective policies during learning, the system employs an exploration strategy. The exploration strategy may include:
1. ϵ-Greedy: With probability ϵ, the system selects a random action; otherwise, it selects the action with the highest Q-value or probability under the current policy. The exploration rate e may be annealed over time (e.g., starting at ϵ=0.3 and decaying to ϵ=0.01).
2. Boltzmann Exploration (Softmax): The system samples actions according to a probability distribution derived from Q-values or policy outputs, with a temperature parameter controlling randomness.
3. Gaussian Noise: For continuous action spaces (e.g., brightness level), the system adds Gaussian noise to the policy output during exploration.
4. Intrinsic Motivation: The system augments the reward with an intrinsic curiosity bonus (e.g., based on prediction error or state visitation counts) to encourage exploration of novel states.

### H. Guardrails Integration and Constraint Enforcement

As shown in FIG. 9, even in the RL embodiment, the Deterministic Policy Layer (Section 7.G) remains active. The policy ulo proposes an action at, but this action is subject to constraint evaluation before execution. If at violates any Guardrail constraint, the system projects it to the nearest admissible action at or replaces it with a safe fallback.

This constraint enforcement ensures that the RL policy never produces unsafe, uncomfortable, or obnoxious automation, regardless of what the policy has learned. For example:
If the policy proposes turning on lights at 100% brightness at 2 AM, the Guardrails Layer may clamp this to a nightlight level (e.g., 10%).
If the policy proposes a fade rate of 200%/sec, the Guardrails Layer clamps it to the maximum allowed rate (e.g., 50%/sec).
If the policy proposes actuating during a configured “manual override lockout” period (e.g., immediately after a user correction), the Guardrails Layer blocks the action entirely.

The RL algorithm receives feedback (reward) based on the actual executed action

$${a}_{t}^{*} ,$$

not the unconstrained proposal αₜ. This ensures that the policy learns to respect constraints over time and proposes actions that are increasingly likely to pass the Guardrails Layer without modification.

### I. Training Modes and Deployment Strategies

The RL embodiment supports multiple training and deployment strategies:
1. Online Learning (Real-Time Adaptation): The policy is updated continuously during normal operation, learning from each interaction in real-time. This mode enables rapid personalization but may introduce temporary instability during the exploration phase.
2. Offline Batch Learning: The node logs trajectories (sequences of observations, actions, rewards) during normal operation and periodically performs batch policy updates using the accumulated data. This mode enables more stable learning and can leverage replay buffers or experience replay techniques to improve sample efficiency.
3. Simulation-Based Pre-Training: Before deployment, the policy is pre-trained in a simulated environment modeling home topology, occupant movement patterns, sensor noise characteristics (PIR, proximity, ambient/IR, current, optional mmWave), and user preferences. The pre-trained policy is then fine-tuned on-device using real household data.
4. Hybrid Learning: The policy is initialized with a pre-trained model (from simulation or baseline heuristics), then personalized on-device through online learning, combining the benefits of warm-start initialization with household-specific adaptation.

Privacy-preserving federated learning may be employed: each household's node updates its local policy based on local data, and only aggregated model updates (not raw sensor streams or user behavior data) are shared with a central server to improve a global initialization policy. This approach preserves user privacy while enabling collective improvement across deployed systems.

### J. Example Operational Flow

The RL-augmented system may operate according to the following flow:
1. Observation Collection: The node derives observation vector oₜ from one or more sensor features (PIR waveform, proximity, ambient/IR, current, optional mmWave) and, optionally, network context messages from other nodes.
2. Policy Action Proposal: The RL policy μ_{θ} proposes an action αₜ (e.g., “turn ON at 80% brightness with 2-second fade”).
3. Constraint Evaluation (Guardrails): The Deterministic Policy Layer evaluates the proposed action against configured constraints (max brightness, min dwell time, time-of-day rules, manual override lockout, ambient light gating, etc.). If constraints are violated, the action is projected to an admissible action

$${a}_{t}^{*}$$

or replaced with a safe fallback.
4. Action Execution: The node executes the approved action

$${a}_{t}^{*} ,$$

actuating the load and/or indicator LEDs as specified.
5. Outcome Monitoring: The node monitors the outcome using available sensors:
   Load current sensing confirms successful actuation or detects failures.
   Ambient/IR sensors detect changes in illumination.
   PIR and optional mm Wave sensors track continued occupancy or departure.
   Proximity sensors detect whether the user approaches the switch (indicating possible intent to override).
6. Reward Computation: Within a time window Δₜ following the action, the node computes reward rₜ:
   If the user performs a manual correction (button press, dim adjustment, gesture override), a negative reward is generated based on the correction type and timing.
   If no correction occurs and the action appears to have met user needs (e.g., maintained appropriate illumination, enabled path lighting), a positive reward is generated.
   Energy consumption, comfort metrics, and actuation success/failure are incorporated into the reward as specified in Section 10.D.
7. Policy Update: The policy parameters θ are updated (either immediately in online learning, or in a batch update using logged experience) to increase the likelihood of actions that maximize cumulative reward, thereby reducing future user corrections while meeting illumination and energy objectives.

Over time, this process enables the RL policy to learn household-specific preferences, such as:
Preferred brightness levels by time of day (e.g., 100% during afternoon, 30% during evening, 10% nightlight mode after 11 PM).
Tolerance for proactive path lighting (e.g., some users appreciate lights turning on before entering a room, others find it intrusive).
Sensitivity to glare and preferred ramp rates (e.g., gradual 5-second fades vs. instant transitions).
Zone-specific behaviors (e.g., kitchen lights should always be bright, bedroom lights should be dimmer and slower to actuate).
   K. Integration with Other Embodiments

This RL embodiment is compatible with and can be combined with the other embodiments described in this specification:
Integration with Preferred Embodiment (Sections 4-7): The RL policy may use the Markov transition graph (Sections 4/7) and predictive look-ahead (Section 7.F) as input features to oₜ, or the RL policy may replace the Markov predictor entirely, learning transition patterns implicitly through experience.
Integration with First Alternative Embodiment (Section 8): The variable-order Markov predictor and waveform-based occupant profiling can provide rich features for the RL observation vector, enabling the policy to condition its actions on detailed movement patterns and occupant characteristics.
Integration with Second Alternative Embodiment (Section 9): The HMM/DBN belief state bₜ(Zᵢ) can be included as a feature in oₜ, providing the RL policy with a probabilistic estimate of occupant location and intent, or the RL policy can operate over the latent belief space directly.

In all cases, the Causal Action Protocol (Section 3), Distributed Consistency mechanisms (Section 2), Waveform Processing (Section 5), and Deterministic Policy Layer (Section 7.G) remain active, ensuring that the RL-augmented system maintains loop suppression, conflict resolution, efficient communication, and safety constraints.

### L. Benefits of the RL Embodiment

The RL embodiment provides several advantages over fixed heuristics, rule-based systems, and static predictive models:
1. Learning from Manual Corrections: The policy explicitly treats manual user interventions as negative feedback signals, learning not just what patterns occur (as in the Markov embodiments) but which automated actions users find acceptable or objectionable. This enables the system to learn user preferences about automation behavior itself (e.g., “don't turn lights on proactively in the bedroom” or “use gradual fades in the evening”), beyond simply learning movement patterns.
2. Multi-Objective Optimization: The reward function balances competing objectives (user satisfaction, energy efficiency, comfort, actuation reliability) in a unified optimization framework, allowing the system to find policies that optimize across these dimensions rather than treating them as separate heuristics or hard constraints.
3. Continuous Policy Improvement: As the household's patterns and preferences evolve (e.g., seasonal changes, new occupants, shifting routines), the RL policy continuously updates through ongoing reward feedback, adapting not just transition frequencies but the decision-making policy itself.
4. Adaptation to User Tolerance: By observing which automated actions trigger manual corrections and which do not, the RL policy learns household-specific tolerance levels (e.g., how aggressive path lighting should be, acceptable brightness ranges by time of day) that may differ significantly from default assumptions.
5. Graceful Sensor Degradation: If sensors fail or degrade (e.g., PIR becomes less sensitive, proximity sensor malfunctions), the RL policy can adapt by discovering compensatory behaviors through the reward signal, rather than requiring explicit recalibration or relying solely on pattern frequency counts.

Despite these benefits, the RL embodiment retains the safety and predictability guarantees of the Deterministic Policy Layer, ensuring that learned behaviors never violate configured hard constraints or produce obnoxious automation.

1. A distributed environmental control system for predictive, sensor-driven load actuation, the system comprising: a plurality of control nodes, each control node comprising a processor, a wireless transceiver configured to communicate over a mesh network, at least one sensor configured to detect occupancy or environmental conditions, and load control circuitry configured to actuate at least one controllable load; wherein each control node is configured to execute a local inference engine that predicts occupancy state and/or user movement between zones based on locally observed sensor data and learned transition patterns, to make autonomous actuation decisions for a locally connected controllable load based on local sensor data, locally computed predictions, and received information from other control nodes, and to exchange ordered control messages with other control nodes; and wherein, for a shared zone in which multiple control nodes control loads associated with said shared zone, the system is configured to selectively operate in (i) a Runtime Actuation Authority mode in which a single control node is dynamically designated as a Runtime Actuation Authority for said shared zone based on sensor-derived context and user interaction recency, said Runtime Actuation Authority being distinct from network provisioning authority and (ii) a contextual coordination mode in which multiple control nodes coordinate based on shared state without requiring a Runtime Actuation Authority.

2. The system of claim 1, wherein the ordered control messages comprise a family of message types sharing common distributed-consistency infrastructure including a unique message identifier, a logical timestamp, an originating node identifier, and an optional message authentication field.

3. The system of claim 2, wherein the family of message types comprises at least: (i) action event packets conveying automated actuation outcomes or decisions, (ii) sensor update messages conveying sensor telemetry or derived features, (iii) waveform update messages conveying compressed waveform encodings, (iv) model update messages conveying learned model parameters, (v) belief exchange messages conveying probabilistic belief distributions, and (vi) Runtime Actuation Authority messages conveying authority claims or authority state.

4. The system of claim 1, further comprising a causal action protocol in which each control node generates and/or receives an action event packet corresponding to an automated actuation and stores a record of the action event packet in a recent action cache to enable deduplication and loop suppression.

5. The system of claim 4, wherein an action event packet comprises: a globally unique action identifier, a logical timestamp, an action type, an originating node identifier, and an affected zone identifier.

6. The system of claim 4, wherein the action event packet further comprises a causal chain identifying one or more prior action identifiers that causally contributed to a current action.

7. The system of claim 4, wherein the recent action cache stores a first-seen timestamp for a given action identifier and the first-seen timestamp is not refreshed upon duplicate receipt of the given action identifier.

8. The system of claim 4, wherein the recent action cache enforces a hybrid eviction policy comprising both (i) time-based eviction using a retention duration and (ii) count-based eviction using a maximum capacity.

9. The system of claim 4, wherein an action event packet includes a cache retention control field encoded as at least one of (i) a maximum age measured from first receipt at a receiving node or (ii) an absolute expiry timestamp.

10. The system of claim 9, wherein, when the cache retention control field comprises an absolute expiry timestamp, a receiving node applies a clock-skew tolerance ε in determining whether the action event packet is expired.

11. The system of claim 4, wherein a proposed automated action is suppressed based on the recent action cache when the proposed automated action is determined to be causally downstream of a recently observed action event packet within a suppression window.

12. The system of claim 11, wherein loop suppression comprises at least one of: (i) strict suppression that blocks the proposed automated action, (ii) a confidence-penalty suppression that reduces a confidence score associated with the proposed automated action, or (iii) causal-chain cycle detection that suppresses the proposed automated action upon detecting a causal cycle.

13. The system of claim 1, wherein each control node maintains a logical clock and updates the logical clock upon generating or receiving an ordered control message to establish a partial order on events, wherein all ordering, conflict resolution, and coordination mechanisms operate using said logical clock without requiring synchronized physical clocks or network time synchronization protocols.

14. The system of claim 1, wherein conflicting automated actions are resolved using deterministic total-order resolution based on an ordering tuple comprising an authority epoch number, a logical timestamp, and a node identifier.

15. The system of claim 2, wherein the logical timestamp and unique message identifier in ordered control messages serve domain-specific actuation safety functions including at least two of: (i) causal loop detection and suppression preventing automated actions from triggering cascading sensor events that cause further automated responses, (ii) deterministic convergence of conflicting actuation commands to a single outcome to prevent load state oscillation, (iii) cache-based deduplication preventing duplicate physical actuations from redundant message propagation, or (iv) causal chain tracking enabling credit assignment for reinforcement learning from user corrections.

16. The system of claim 14, further comprising a conflict notification message type that indicates a deterministic winner among conflicting actions, and wherein a losing node rolls back or refrains from applying a losing action responsive to said conflict notification.

17. The system of claim 1, wherein designation of the Runtime Actuation Authority for the shared zone is based on most recent manual interaction with a control node associated with the shared zone.

18. The system of claim 17, wherein, upon an authority transfer, an authority epoch is incremented, and authority is deterministically tie-broken using a node identifier when multiple manual interactions are contemporaneous within a defined tolerance window.

19. The system of claim 17, wherein Runtime Actuation Authority maintenance comprises a lease, heartbeat, or periodic announcement mechanism, and wherein authority state is persisted to non-volatile storage such that a rebooted node does not spuriously preempt authority.

20. The system of claim 1, further comprising a deterministic policy layer that gates, modifies, or projects proposed automated actions to satisfy one or more configured constraints including maximum brightness, maximum fade rate, occupancy timeout, time-of-day rules, and minimum on/off dwell times.

21. The system of claim 20, wherein the deterministic policy layer applies dual-threshold hysteresis using a first threshold for turning a load on and a second threshold for turning the load off, and wherein the minimum on/off dwell times prevent oscillatory actuation.

22. The system of claim 20, wherein each zone is assigned a Zone Profile selected from a categorical set of Zone Profiles, wherein one or more constraints are modulated as a function of the Zone Profile, and wherein the Zone Profile is at least one of (i) automatically inferred from observed sensor patterns and user interaction history, (ii) dynamically updated based on detected occupancy patterns or learned behavioral context, or (iii) configured during commissioning and subsequently adapted based on runtime observations.

23. The system of claim 22, wherein the system maintains a confidence score for each Zone Profile assignment and triggers profile re-evaluation when observed sensor patterns diverge from expected profile characteristics beyond a stability threshold.

24. The system of claim 1, wherein the local inference engine comprises a probabilistic state machine representing zones as nodes of a directed graph and representing transitions between zones as edges having weights updated online based on observed transitions.

25. The system of claim 24, wherein edge weights are subject to exponential decay using per-edge timestamps and lazy projection at probability computation time.

26. The system of claim 24, wherein the directed graph maintains structural edge persistence such that adjacency relationships are retained while only behavioral weights decay.

27. The system of claim 24, wherein transition probabilities are computed using at least one of an inactive threshold W_min or a smoothing constant α to avoid numerical instability and to avoid zero-probability transitions.

28. The system of claim 24, wherein the local inference engine performs a k-step look-ahead prediction by enumerating candidate paths and computing a path confidence score using a product of transition probabilities along each path.

29. The system of claim 28, wherein the k-step look-ahead prediction is contextually gated based on at least one of ambient light conditions, user stationarity, Zone Profile, or a first-step confidence threshold.

30. The system of claim 24, wherein the local inference engine comprises a variable-order Markov model maintaining second-order transition weights conditioned on both a current zone and a previous zone, and further comprising a fallback strategy that degrades from second-order to first-order and then to a uniform distribution when insufficient data exists.

31. The system of claim 1, wherein the at least one sensor comprises a passive infrared sensor producing a waveform, and wherein the system determines a direction-of-travel indicator from waveform asymmetry.

32. The system of claim 1, wherein the at least one sensor comprises a proximity sensor, and wherein a proposed actuation is gated by proximity such that proximity within a threshold suppresses actuation or proximity consistent with approach increases an actuation confidence.

33. The system of claim 1, wherein the system derives a feature signature from a compressed waveform representation and maintains multiple transition-weight profiles indexed by clusters of said feature signature to provide occupant-like personalization without storing explicit user identities.

34. The system of claim 1, wherein at least one control node comprises an image sensor and is configured to perform local, edge-based computer vision processing on image data to derive occupancy-related features that are incorporated into an observation vector of the local inference engine as supplemental sensor evidence for occupancy prediction and actuation decisions.

35. The system of claim 34, wherein the control node is configured to transmit over the mesh network derived features computed from the image data while refraining from transmitting raw images or raw video streams.

36. The system of claim 34, wherein the derived features comprise at least one of: an occupancy presence indicator, a person count, bounding box coordinates, trajectory vectors, optical-flow descriptors, pose sequence descriptors, gesture classification labels, or posture-derived features, said derived features being formatted for incorporation into the observation vector of the local inference engine.

37. The system of claim 34, wherein the control node refrains from persistently storing the raw images or raw video streams.

38. The system of claim 34, wherein the control node is configured to determine a direction-of-travel indicator based on optical flow analysis or pose sequence analysis.

39. The system of claim 34, wherein the direction-of-travel indicator derived from image processing is fused with non-image sensor evidence and incorporated into at least one of: a Markov transition confidence that conditions predictive look-ahead actuation, a hidden Markov model or dynamic Bayesian network emission probability that updates latent occupancy belief, or a reinforcement learning observation vector that influences policy-based actuation decisions gated by the deterministic policy layer.

40. The system of claim 34, wherein the control node is configured to recognize a gesture from the image data and to treat the recognized gesture as an explicit control input for actuation of the controllable load.

41. The system of claim 34, wherein the control node is configured to derive a movement signature from gait or posture, to assign said movement signature to a feature cluster, and to maintain cluster-conditioned transition weights enabling occupant-like personalization of predictive actuation without storing an explicit user identity.

42. The system of claim 34, wherein computer vision functionality is selectively disabled based on at least one of a physical switch input, a software configuration, a time-based schedule, or a Zone Profile associated with a zone.

43. The system of claim 34, wherein the control node provides an indicator output that signals when image sensing or computer vision processing is active, and wherein computational load is reduced by at least one of: processing at reduced resolution, processing at reduced frame rate, utilizing hardware acceleration, or selectively activating computer vision processing responsive to a trigger from a non-image sensor.

44. The system of claim 1, wherein waveform data is transmitted as a compressed parametric encoding comprising keypoints including extrema keypoints and, optionally, slope-change keypoints selected based on a slope-change threshold and a keypoint separation constraint.

45. The system of claim 44, wherein the compressed parametric encoding comprises at least one of: (i) delta-encoded time offsets between keypoints, (ii) absolute or quantized amplitudes associated with keypoints, (iii) a keypoint type field distinguishing extrema keypoints from slope-change keypoints, or (iv) an end-of-event duration field.

46. The system of claim 44, wherein the local inference engine derives waveform features directly from the keypoints without reconstructing a full-resolution waveform.

47. The system of claim 1, wherein the deterministic policy layer implements futile actuation suppression by monitoring load current after issuing an actuation command, marking a load as non-functional after N_fail consecutive failures, and suppressing subsequent automated actuations until a successful manual actuation or detected current draw re-enables automation.

48. The system of claim 1, wherein the local inference engine comprises a hidden Markov model or dynamic Bayesian network maintaining a belief distribution over latent occupancy states and performing Bayesian filtering updates responsive to sensor evidence.

49. The system of claim 48, wherein belief updates are performed using at least one of event-driven time steps, fixed-interval time steps, or fixed-lag smoothing, and wherein belief exchange messages convey belief distributions between control nodes.

50. The system of claim 1, wherein the local inference engine comprises a reinforcement learning controller that proposes actions based on an observation vector comprising sensor features and wherein a reward function includes at least a user-correction penalty, an energy cost proxy, and a futile actuation penalty.

51. The system of claim 50, wherein actions proposed by the reinforcement learning controller are subject to constraint enforcement by the deterministic policy layer prior to execution.

52. The system of claim 1, wherein ordered control messages include an application-layer security mechanism comprising at least one of a shared-key message authentication code, per-node keyed authentication, or an asymmetric digital signature.

53. The system of claim 52, further comprising anti-replay protection using at least one of a nonce, a monotonic sequence number, or a timestamp, and further comprising key rotation or key revocation messaging.

54. The system of claim 1, wherein the mesh network employs at least one of Bluetooth Mesh, Thread, Matter, Zigbee, or Z-Wave, and wherein ordered control messages are transmitted as application-layer payloads using any message delivery mechanism supported by the selected network stack including unicast, broadcast flooding, standards-based IP multicast, or protocol-native group messaging, without requiring any specific multicast routing architecture, distribution node, or encapsulation scheme.

55. The system of claim 1, wherein the system performs inference and learning locally without requiring a hub or cloud connectivity for operation.

56. The system of claim 1, further comprising federated learning in which only model parameters are communicated to a server for aggregation and a global initialization is communicated to control nodes, without communicating raw sensor streams.

57. A method for predictive, sensor-driven distributed environmental control executed by a plurality of control nodes in a mesh network, the method comprising: collecting local sensor data at a control node; generating, by a local inference engine of the control node, a prediction of occupancy state and/or a predicted transition between zones based on learned transition patterns; receiving ordered control messages from one or more other control nodes; determining an actuation decision for a locally connected controllable load based on the local sensor data, the prediction, and the ordered control messages; applying a deterministic policy layer to gate or project the actuation decision to satisfy configured constraints; actuating the locally connected controllable load responsive to the gated actuation decision; and broadcasting an action event packet to the plurality of control nodes.

58. The method of claim 57, further comprising storing, in a recent action cache, a record of the action event packet indexed by a unique action identifier and suppressing a proposed automated action based on the recent action cache.

59. The method of claim 58, wherein storing further comprises storing a first-seen timestamp that is not refreshed upon duplicate receipt of the unique action identifier and evicting cache entries using both time-based eviction and count-based eviction.

60. The method of claim 57, further comprising resolving conflicting automated actions using deterministic total-order resolution based on an ordering tuple comprising an authority epoch, a logical timestamp, and a node identifier.

61. The method of claim 57, further comprising designating a Runtime Actuation Authority for a shared zone based on most recent manual interaction and incrementing an authority epoch upon authority transfer.

62. The method of claim 57, further comprising computing transition probabilities on a zone graph using exponentially decayed edge weights and lazy projection using per-edge timestamps while preserving structural adjacency.

63. The method of claim 57, further comprising performing a k-step look-ahead prediction by enumerating paths and computing path confidence scores and gating a downstream actuation based on contextual conditions including ambient light and Zone Profile.

64. The method of claim 57, further comprising detecting futile actuation by monitoring load current after an actuation command, suppressing future automated commands after N_fail consecutive failures, and re-enabling automation upon detection of a successful manual actuation.

65. The method of claim 57, further comprising transmitting a compressed waveform encoding as keypoints comprising extrema and optional slope-change points and deriving waveform features directly from the keypoints without reconstructing a full waveform.

66. A non-transitory computer-readable medium storing instructions that, when executed by one or more processors of one or more control nodes of a distributed environmental control system, cause the one or more control nodes to perform the method of claim 57.
